(19) United States
(12) Patent Application Publication
(10) Pub. No.: US 2006/0257613 A1
(43) Pub. Date: Nov. 16, 2006

(54) Metal complexes as light-absorbing compounds in the information layer of optical data carriers

(76) Inventors: Horst Berneth, Leverkusen (DE); Friedrich-Karl Bruder, Krefeld (DE); Rainer Hagen, Leverkusen (DE); Karin Hassenruck, Dusseldorf (DE); Serguei Kostromine, Swisttal (DE); Christa Maria Kruger, Scheverdingen (DE); Timo Meyer-Friedrichsen, Krefeld (DE); Rafael Oser, Krefeld (DE); Josef-Walter Stawitz, Odenthal (DE); Monika Engel, Leverkusen (DE)

Correspondence Address: Lanxess Corporation;Law & Intellectual Property Department, 111 Ride Park West Drive, Pittsburgh, PA, 15275-1112, US

(21) Appl. No.: 10/544,449

(22) PCT Filed: Jan. 31, 2004
(86) PCT No.: PCT/EP04/00879

§ 371 Date: May 2, 2006

(30) Foreign Application Priority Data
Feb. 13, 2003 (DE) 103 05 925.3
Mar. 17, 2003 (DE) 103 11 562.5

(51) Int. Cl. B32B 3/02

(52) U.S. Cl. 428/64.4

(57) ABSTRACT

Novel metal complexes for optical data carriers comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written on or read by means of blue or red light, preferably laser light, where the information layer comprises a light-absorbent compound and, if desired, a binder, characterized in that at least one such metal complex is used as light-absorbent compound, have been found.

The invention relates to metal complexes, to a process for preparing them, to the azo compounds functioning as ligands in the metal complexes and their preparation, to the coupling components on which the azo compounds are based and their preparation and to optical data stores comprising the metal complexes in their information layer, and also to the application of the abovementioned dyes to a polymer substrate, in particular polycarbonate, by spin coating or vapour deposition.

Write-once optical data carriers using specific light-absorbent substances or mixtures thereof are particularly suitable for use in high-density writable optical data stores which operate with blue laser diodes, in particular GaN or SHG laser diodes (360-460 nm) and/or for use in DVD-R or CD-R disks which operate with red (635-660 nm) or infrared (780-830 nm) laser diodes.

The write-once compact disk (CD-R, 780 mm) has recently experienced enormous volume growth and represents the technically established system.

The next generation of optical data stores—DVDs—is currently being introduced onto the market. Through the use of shorter-wave laser radiation (635-660 nm) and higher numerical aperture NA, the storage density can be increased. The writable format in this case is DVD-R (DVD-R and also DVD+R).

Today, optical data storage formats which use blue laser diodes (based on GaN, JP 08 191 171 or Second Harmonic Generation SHG JP 09 050629) (360 nm-460 nm) with high laser power are being developed. Writable optical data stores will therefore also be used in this generation. The achievable storage density depends on the focussing of the laser spot on the information plane. The spot size scales with the laser wavelength λ/NA. NA is the numerical aperture of the objective lens used. In order to obtain the highest possible storage density, the use of the smallest possible wavelength λ is the aim. At present 390 nm is possible on the basis of semiconductor laser diodes.

The patent literature describes dye-based writable optical data stores which are equally suitable for CD-R and DVD-R (DVD-R and DVD+R) systems (JP-A 11 043 481 and JP-A 10 181 206). To achieve a high reflectivity and a high modulation height of the read-out signal and also to achieve sufficient sensitivity in writing, use is made of the fact that the IR wavelength of 780 nm of CD-Rs is located at the foot of the long wavelength flank of the absorption peak of the dye and the red wavelength of 635 nm or 650 nm of DVD-Rs (DVD-Rs and DVD+Rs) is located at the foot of the short wavelength flank of the absorption peak of the dye. In JP-A 02 557 335, JP-A 10 058 828, JP-A 06 336 086, JP-A 02 865 955, WO-A 09 917 284 and U.S. Pat. No. 5,266,699, this concept is extended to the 450 nm working wavelength region on the short wavelength flank and the red and IR region on the long wavelength flank of the absorption peak.

Apart from the abovementioned optical properties, the writable information layer comprising light-absorbent organic substances has to have a substantially amorphous morphology to keep the noise signal during writing or reading as small as possible. For this reason, it is particularly preferred that crystallization of the light-absorbent substances be prevented in the application of the substances by spin coating from a solution, by vapour deposition and/or sublimation during subsequent covering with metallic or dielectric layers under reduced pressure.

The amorphous layer comprising light-absorbent substances preferably has a high heat distortion resistance, since otherwise further layers of organic or inorganic material which are applied to the light-absorbent information layer by sputtering or vapour deposition would form blurred boundaries due to diffusion and thus adversely affect the reflectivity. Furthermore, a light-absorbent substance which has insufficient heat distortion resistance can, at the boundary to a polymeric support, diffuse into the latter and once again adversely affect the reflectivity.

A light-absorbent substance whose vapour pressure is too high can sublime during the abovementioned deposition of further layers by sputtering or vapour deposition in a high vacuum and thus reduce the layer thickness to below the desired value. This in turn has an adverse effect on the reflectivity.

JP 11-310 728 describes an optical recording medium comprising particular azo metal complexes in its information layer. These azo metal complexes contain azo dyes containing at least two fluorine atoms. The azo dyes additionally contain a group of the formula —NH—SO₂—Y, where Y is an alkyl or aryl radical. The optical data store is suitable for a writing and reading laser wavelength of 630-660 nm.

It is therefore an object of the invention to provide suitable compounds which satisfy the high requirements (e.g. light stability, favourable signal/noise ratio, damage-free application to the substrate material, and the like) for use in the information layer in a write-once optical data carrier, in particular for high-density writable optical data store formats in a laser wavelength range from 340 to 680 nm.

Surprisingly, it has been found that light-absorbent compounds selected from the group of specific metal complexes can satisfy the abovementioned requirement profile particularly well.

The invention accordingly provides metal complexes having at least one ligand of the formula (I) 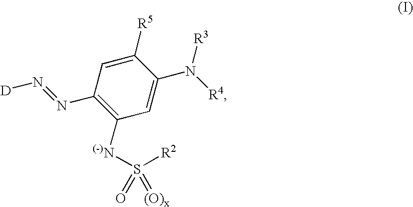
where
D is a five-membered pseudoaromatic heterocyclic radical,
x is 0 or 1,
R₂ is substituted or unsubstituted C₆-C₁₀-aryl, substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperidino,
R⁵ is hydrogen, chlorine, methyl or methoxy or
R³;R⁵ together form a —CH₂)₂—, —(CH₂)₃— or —CH₂)₂—O— bridge,
where D must not be unsubstituted or substituted thiazol-2-yl, benzothiazol-2-yl, benzoxazol-2-yl, benzimidazol-2-yl or 1,3,4-triazol-2-yl when x is 1 and R² is substituted or unsubstituted C₆-C₁₀-aryl.

In a preferred embodiment,
R² is substituted or unsubstituted C₆-C₁₀-aryl or a five- or six-membered aromatic or pseudoaromatic heterocyclic ring and
R⁵ is hydrogen, methyl or methoxy, where
D must not be substituted or unsubstituted thiazol-2-yl, benzothiazol-2-yl, benzoxazol-2-yl, benzimidazol-2-yl or 1,3,4-triazol-2-yl when x is 1.

In a preferred embodiment, the metal complexes are present as 1:1 or 1:2 metal:azo complexes.

Distinct preference is given to metal complexes containing two identical or different ligands of the formula (I).

Preference is given to metal complexes which are characterized in that they correspond to the formula (Ia) 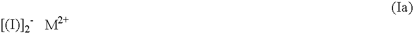
where the two ligands of the formula (I) each have, independently of one another, one of the meanings given above and

M is a metal.

Preferred metals are divalent metals, transition metals or rare earths, in particular Mg, Ca, Sr, Ba, Cu, Ni, Co, Fe, Zn, Pd, Pt, Ru, Th, Os, Sm. Preference is given to the metals Pd, Fe, Zn, Cu, Ni and Co. Particular preference is given to Ni.

D is preferably 1,3-thiazol-4-yl, 1,2-thiazol-3-yl, benzoisothiazol-3-yl, 1,3-oxazol-2-yl, 1,2-oxazol-3-yl, imidazol-2-yl, imidazol-4-yl, pyrazol-5-yl, 1,3,4-thiadiazol-2-yl, 1,2,4-thiadiazol-5-yl, 1,2,4-thiadiazol-3-yl or 1,3,4-oxadiazol-2-yl which may each be substituted by C₁-C₆-alkyl, C₁-C₆-alkoxy, fluorine, chlorine, bromine, iodine, cyano, —C(═NH)—O—C₁-C₆-alkyl, nitro, C₁-C₆-alkoxycarbonyl, C₁-C₆-alkylthio, C₁-C₆-acylamino, formyl, C₂-C₆-alkanoyl, C₆-C₁₀-aryl, C₆-C₁₀-aryloxy, C₆-C₁₀-arylcarbonylamino, mono- or di-C₁-C₆-alkylamino, N—C₁-C₆-alkyl-N—C₆-C₁₀-arylamino, pyrrolidino, morpholino, piperazino or piperidino.

D is particularly preferably 1,3-thiazol-4-yl which may bear up to two identical or different radicals from the group consisting of chlorine, fluorine, methoxy, methylthio, phenyl and cyano as substituents, imidazol-2-yl which may bear up to two identical or different radicals from the group consisting of chlorine, methyl, methoxy, phenyl, cyano, —C(═NH)—OCH₃, nitro, methoxycarbonyl and ethoxycarbonyl as substituents, pyrazol-5-yl which may bear up to two identical or different radicals from the group consisting of chlorine, methyl, methoxy, phenyl, cyano and nitro as substituents, 1,3,4-thiadiazol-2-yl which may bear chlorine, bromine, methoxy, phenoxy, methanesulphonyl, methylthio, ethylthio, dimethylamino, diethylamino, diisopropylamino, N-methyl-N-cyanoethylamino, N,N-biscyanoethylamino, N-methyl-N-hydroxyethylamino, N-methyl-N-benzylamino, N-methyl-N-phenylamino, anilino, pyrrolidino, piperidino or morpholino radicals as substituents, 1,2,4-thiadiazol-5-yl which may bear chlorine, methyl, ethyl, methoxy, phenoxy, methylthio, methanesulphonyl, benzylthio, benzylsulphonyl, benzenesulphonyl, phenyl, pyridyl, dimethylamino or anilino radicals as substituents, 1,2,4-thiadiazol-3-yl which may bear methyl or phenyl radicals as substituents.

In a preferred embodiment, R² is substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical, where D is no longer subject to any restrictions (disclaimer no longer applies).

R² is particularly preferably a substituted or unsubstituted five- or six-membered aromatic or pseudoaromatic heterocyclic radical.

Particular preference is given to metal complexes which have at least one ligand of the formula (1) 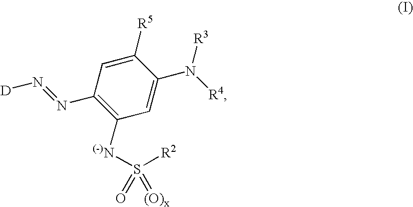
in which
D is a radical of the formula 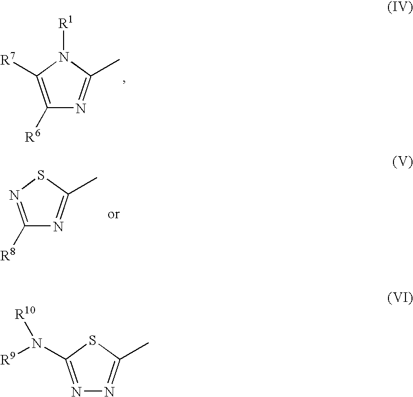
R¹ is hydrogen, substituted or unsubstituted C₁-C₆-alkyl or substituted or unsubstituted C₇-C₁₂-aralkyl,
x is 0 or 1,
R² is substituted or unsubstituted C₆-C₁₀-aryl, substituted or unsubstituted C₆-C₁₀-aryl-vinyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperazino,
R⁵ is hydrogen, methyl or methoxy or
R³;R⁵ together form a —CH₂)₂—, —(CH₂)₃— or —CH₂)₂—O— bridge,
R⁶ and R⁷ are each, independently of one another, cyano, C₁-C₄-alkoxycarbonyl or —C(═NH)—C₁-C₄-alkyl,
R⁸ is substituted or unsubstituted C₆-C₁₀-aryl, substituted or unsubstituted pyridyl, C₁-C₆-alkylthio, C₇-C₁₀-aralkylthio, substituted or unsubstituted C₆-C₁₀-arylthio, C₁-C₆-alkylsulphonyl, C₇-C₁₀-aralkylsulphonyl or substituted or unsubstituted C₆-C₁₀-arylsulphonyl,
R⁹ and R¹⁰ are each, independently of one another, substituted or unsubstituted C₁-C₆-alkyl, substituted or unsubstituted C₇-C₁₀-aralkyl or substituted or unsubstituted C₆-C₁₀-aryl or
NR⁹R¹⁰ is pyrrolidino, piperidino, morpholino, piperazino or N—C₁-C₆-alkyl-piperidino.

Possible substituents on the alkyl or aralkyl radicals are halogen, in particular Cl or F, nitro, cyano, CO—NH₂, alkoxy, trialkylsilyl or trialkylsiloxy. The alkyl radicals can be linear or branched and may be partially halogenated or perhalogenated. Examples of substituted alkyl radicals are trifluoromethyl, chloroethyl, cyanoethyl, methoxyethyl. Examples of branched alkyl radicals are isopropyl, tert-butyl, 2-butyl, neopentyl.

Preferred substituted or unsubstituted C₁-C₆-alkyl radicals are methyl, ethyl, n-propyl, isopropyl, n-butyl, 2-butyl, isobutyl, tert-butyl, n-pentyl, n-hexyl, perfluorinated methyl, perfluorinated ethyl, 2,2-trifluoroethyl, 3,3,3-trifluoroethyl, perfluorobutyl, cyanoethyl, methoxyethyl, chloroethyl. Particularly preferred substituted or unsubstituted C₁-C₆-alkyl radicals are methyl, ethyl, n-propyl, isopropyl, n-butyl, 2-butyl, isobutyl, tert-butyl, n-pentyl, n-hexyl, cyanoethyl, methoxyethyl, chloroethyl.

Preferred aralkyl groups are, for example, benzyl, phenethyl and phenylpropyl.

Preferred heterocyclic radicals are benzothiazolyl, benzoxazolyl, benzimidazolyl, pyridyl, quinolyl, pyrimidyl, pyrazinyl. If these radicals are substituted, preferred substituents on them are fluorine, chlorine, cyano, nitro, methyl, ethyl, trifluoromethyl, methoxy, ethoxy, acetamino, carboxyl, carboxamide, methoxy-carbonyl, ethoxycarbonyl or phenyl.

Likewise preferred are metal complexes with ligands of the formula (I) in which no fluorine atoms are present.

Preferred radicals R² are substituted or unsubstituted phenyl, styryl, naphthyl, benzothiazolyl, benzoxazolyl, benzimidazolyl, pyridyl, pyridyl N-oxide, quinolyl, pyrimidyl, pyrazinyl.

Particularly preferred radicals R2 are substituted or unsubstituted benzothiazolyl, benzoxazolyl, benzimidazolyl, pyridyl, pyridyl N-oxide, quinolyl, pyrimidyl, pyrazinyl.

Preferred substituents on these radicals R² are fluorine, chlorine, cyano, nitro, methyl, ethyl, trifluoromethyl, methoxy, ethoxy, acetamino, carboxyl, carboxamide, methoxycarbonyl, ethoxycarbonyl or phenyl.

x is preferably 1. Preference is likewise given to x being 0.

The particularly preferred metal complexes of the formula (Ia) each have 2 ligands, as can be seen from the formulae IIa to IIc. It is assumed that they are in the form of the formulae (IIa) to (IIc): 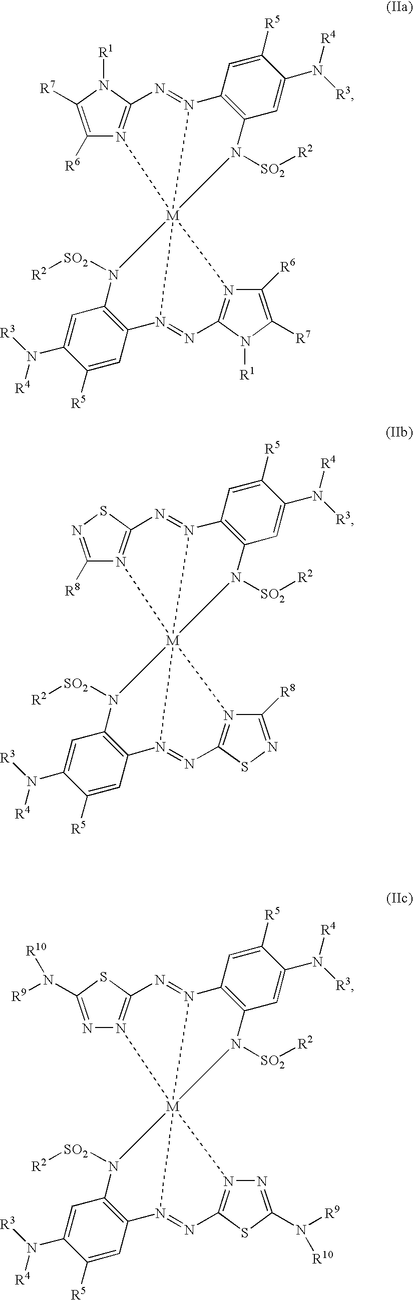
where M and the radicals on the respective azo ligands each have, in dependently of one another, one of the abovementioned meanings. For the purposes of the present patent application, it is assumed that the formulae (IIa), (IIb) and (IIc) represent particular cases of (a).

Further likewise particularly preferred metal complexes of the formula (Ia) are, according to our assumption, in the form of the formulae (IIIa) to (IIIc) 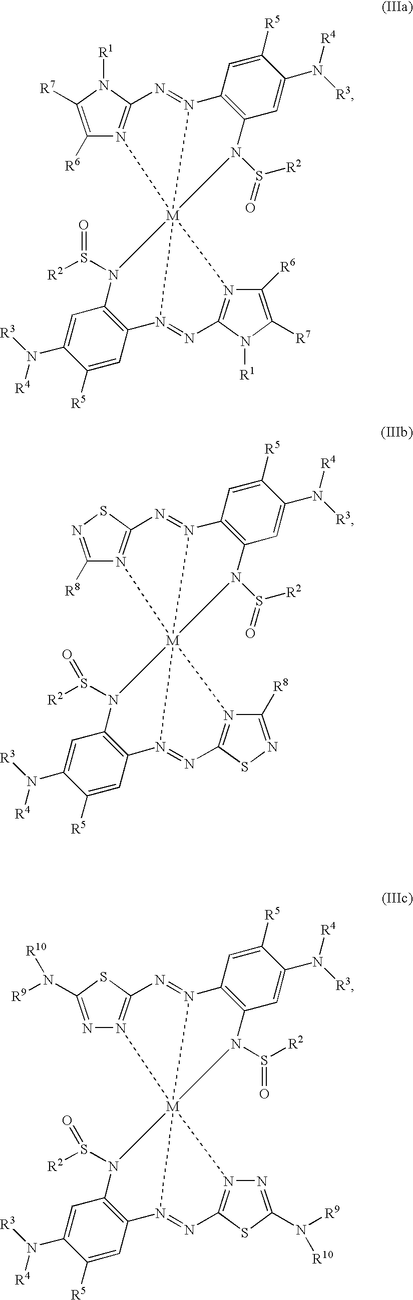
where M and the radicals of the respective azo ligands each have, independently of one another, one of the abovementioned meanings. For the purposes of the present patent application, it is assumed that the respective formulae (IIIa), (IIIb) and (IIIc) are particular cases of (Ia).

Very particular preference is given to metal complexes of the formula (Ia), in particular ones of the formulae (IIa) to (IIc),

in which

R¹ is methyl, ethyl, propyl, butyl, cyanoethyl, methoxyethyl or benzyl, in particular methyl or ethyl,
R² is phenyl, tolyl, anisyl, chlorophenyl, cyanophenyl, nitrophenyl, dicyanophenyl, dinitrophenyl, styryl, benzothiazol-2-yl, 2-, 3- or 4-pyridyl, 5-nitro-2-pyridyl, 3- or 5-trifluoromethyl-2-pyridyl, 5-cyano-2-pyridyl, tetrachloro-2-pyridyl, pyridine N-oxide-2-yl, 2- or 4-chloro-3-pyridyl, 6-methoxy-3-pyridyl, 5-methyl-3-pyridyl, tetrafluoro-4-pyridyl, tetrachloro-4-pyridyl, tetrabromopyridyl, pyridine N-oxide-4-yl, pyrimid-3-yl, in particular phenyl, tolyl, chlorophenyl, styryl, benzothiazol-2-yl, 2-, 3- or 4-pyridyl, 5-nitro-2-pyridyl, 2-chloro-3-pyridyl, tetrachloro-4-pyridyl or pyrimid-3-yl,
R³ and R⁴ are each, independently of one another, methyl, ethyl, propyl, butyl, cyanoethyl, chloroethyl, methoxyethyl, benzyl, phenethyl or phenyl, in particular methyl, ethyl, cyanoethyl, benzyl or phenyl, or
NR³R⁴ is pyrrolidino, piperidino or morpholino, in particular pyrrolidino or piperidino,
R⁵ is hydrogen or
R³;R⁵ is a —CH₂CH₂— or CH₂CH₂CH₂— bridge,
R⁸ is phenyl, pyridyl, methylthio, ethylthio, propylthio, benzylthio, methylsulphonyl, benzylsulphonyl or phenylsulphonyl, in particular phenyl, pyridyl or phenylsulphonyl,
R⁹ and R¹⁰ are each, independently of one another, methyl, ethyl, propyl, butyl, cyanoethyl, chloroethyl, methoxyethyl, benzyl, phenethyl or phenyl, in particular methyl, ethyl, propyl or cyanoethyl, or
NR⁹R¹⁰ is pyrrolidino, piperidino or morpholino, in particular pyrrolidino or piperidino,
   and
M is Pd, Fe, Zn, Cu, Ni or Co,
   where the propyl or butyl radicals may also be branched.

Very particularly preferred metal complexes are those of the formulae (IIb) and (IIc).

Very particular preference is given to metal complexes of the formula (Ia), in particular those of the formulae (IIIa) to (IIIc),

in which

R¹ is methyl, ethyl, propyl, butyl, cyanoethyl, methoxyethyl or benzyl, in particular methyl or ethyl,
R² is phenyl, tolyl, anisyl, chlorophenyl, cyanophenyl, nitrophenyl, dicyanophenyl, dinitrophenyl, styryl, benzothiazol-2-yl, 2-, 3- or 4-pyridyl, 5-nitro-2-pyridyl, 3- or 5-trifluoromethyl-2-pyridyl, 5-cyano-2-pyridyl, tetrachloro-2-pyridyl, pyridine N-oxide-2-yl, 2- or 4-chloro-3-pyridyl, 6-methoxy-3-pyridyl, 5-methyl-3-pyridyl, tetrafluoro-4-pyridyl, tetrachloro-4-pyridyl, tetrabromo-4-pyridyl, pyridine N-oxide-4-yl, pyrimid-3-yl, in particular phenyl, tolyl, chlorophenyl, styryl, benzothiazol-2-yl, 2-, 3- or 4-pyridyl, 5-nitro-2-pyridyl, 2-chloro-3-pyridyl, tetrachloro-4-pyridyl or pyrimid-3-yl,
R³ and R⁴ are each, independently of one another, methyl, ethyl, propyl, butyl, cyanoethyl, chloroethyl, methoxyethyl, benzyl, phenethyl or phenyl, in particular methyl, ethyl, cyanoethyl, benzyl or phenyl, or
NR³R⁴ is pyrrolidino, piperidino or morpholino, in particular pyrrolidino or piperidino,
R⁵ is hydrogen or
R³;R⁵ is a CH₂CH₂— or —CH₂CH₂CH₂— bridge,
R⁸ is phenyl, pyridyl, methylthio, ethylthio, propylthio, benzylthio, methylsulphonyl, benzylsulphonyl or phenylsulphonyl, in particular phenyl, pyridyl or phenylsulphonyl,
R⁹ and R¹⁰ are each, independently of one another, methyl, ethyl, propyl, butyl, cyanoethyl, chloroethyl, methoxyethyl, benzyl, phenethyl or phenyl, in particular methyl, ethyl, propyl or cyanoethyl, or
NR⁹R¹⁰ is pyrrolidino, piperidino or morpholino, in particular pyrrolidino or piperidino,
   and
M is Pd, Fe, Zn, Cu, Ni or Co,
   where the propyl or butyl radicals may also be branched.

The metal complexes of the invention are sold, in particular, as powder or granulated material or as a solution having a solids content of at least 2% by weight. Preference is given to the granulated form, in particular granulated materials having mean particle sizes of from 50 μm to 10 mm, in particular from 100 to 800 μm. Such granulated materials can be prepared, for example, by spray drying. The granulated materials are, in particular, low in dust.

The metal complexes of the invention have a good solubility. They are readily soluble in nonfluorinated alcohols. Such alcohols are, for example, alcohols having from 3 to 6 carbon atoms, preferably propanol, butanol, pentanol, hexanol, diacetone alcohol or else mixtures of these alcohols, e.g. propanol/diacetone alcohol, butanol/diacetone alcohol, butanol/hexanol. Preferred mixing ratios for the mixtures mentioned are, for example, from 80:20 to 99:1, preferably from 90:10 to 98:2.

Preference is likewise given to the concentrated solutions. They have a concentration of at least 1% by weight, preferably at least 2% by weight, particularly preferably at least 5% by weight, of the metal complexes of the invention, in particular ones of the formulae (Ia), (IIa), (IIb), (IIIc), (IIIa), (IIIb) or (IIIc). As solvents for the solutions, preference is given to using 2,2,3,3-tetrafluoropropanol, propanol, butanol, pentanol, hexanol, diacetone alcohol, dibutyl ether, heptanone or mixtures thereof. Particular preference is given to 2,2,3,3-tetrafluoropropanol. Particular preference is likewise given to butanol. Butanol/diacetone alcohol in a mixing ratio of from 90:10 to 98:2 is likewise particularly preferred.

The invention further provides a process for preparing the metal complexes of the invention, which is characterized in that a metal salt is reacted with an azo compound of the formula (Ib) 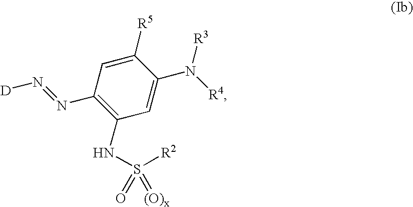
where
D is a five-membered pseudoaromatic heterocyclic radical,
x is 0 or 1,
R² is substituted or unsubstituted C₆-C₁₀-aryl, substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁— to C₆-alkyl-piperidino,
R⁵ is hydrogen, chlorine, methyl or methoxy or
R³;R⁵ together form a —CH₂)₂—, —(CH₂)₃— or —CH₂)₂—O— bridge
   where D must not be unsubstituted or substituted thiazol-2-yl, benzothiazol-2-yl, benzoxazol-2-yl, benzimidazol-2-yl or 1,3,4-triazol-2-yl when x is 1 and R2 is substituted or unsubstituted C₆-C₁₀-aryl.

In this process of the invention, it is also possible to use two or more different azo compounds of the formula (Ib). This then gives a random mixture of metal complexes consisting of complexes which contain two identical ligands of the formula (I) and complexes which contain two different ligands of the formula (I). These mixtures are likewise subject matter of the invention.

The reaction according to the invention is generally carried out in a solvent or solvent mixture, in the presence or absence of basic substances, at from room temperature to the boiling point of the solvent, for example at 20-100° C., preferably 20-50° C. The metal complexes generally either precipitate directly or can be isolated by filtration or they are precipitated by, for example, addition of water, possibly with prior partial or complex removal of the solvent, and isolated by filtration. It is also possible to carry out the reaction directly in the solvent to give the abovementioned concentrated solutions.

For the purposes of the present invention, metal salts are, for example, the chlorides, bromides, sulphates, hydrogen sulphates, phosphates, hydrogen phosphates, dihydrogen phosphates, hydroxides, oxides, carbonates, hydrogen carbonates, salts of carboxylic acids such as formates, acetates, propionates, benzoates, salts of sulphonic acids such as methane sulphonates, trifluoromethanesulphonates or benzenesulphonates of the appropriate metals. The term metal salts likewise encompasses complexes with ligands other than those of the formula (Ia), in particular complexes of acetylacetone and ethyl acetoacetate. Examples of possible metal salts are: nickel acetate, cobalt acetate, copper acetate, nickel chloride, nickel sulphate, cobalt chloride, copper chloride, copper sulphate, nickel hydroxide, nickel oxide, nickel acetylacetonate, cobalt hydroxide, basic copper carbonate, barium chloride, iron sulphate, palladium acetate, palladium chloride and their variants containing water of crystallisation. Preference is given to the acetates of the metals. The metals of the metal salts used are preferably divalent.

Possible basic substances are alkali metal acetates such as sodium acetate, potassium acetate, alkali metal hydrogen carbonates, carbonates or hydroxides, e.g. sodium hydrogen carbonate, potassium carbonate, lithium hydroxide, sodium hydroxide, or amines such as ammonia, dimethylamine, triethylamine, diethanolamine. Such basic substances are particularly advantageous when metal salts of strong acids, e.g. metal chlorides or sulphates, are used.

Suitable solvents are water, alcohols such as methanol, ethanol, propanol, butanol, 2,2,3,3-tetrafluoropropanol, ethers such as dibutyl ether, dioxane or tetrahydrofuran, aprotic solvents such as dimethylformamide, N-methylpyrrolidone, acetonitrile, nitromethane, dimethylsulphoxide. Preference is given to methanol, ethanol and 2,2,3,3-tetrafluoropropanol.

The azo compounds of the formula (Ib) required for preparing the metal complexes of the invention are likewise subject matter of the present invention.

The invention therefore also provides azo compounds of the formula (Ib) 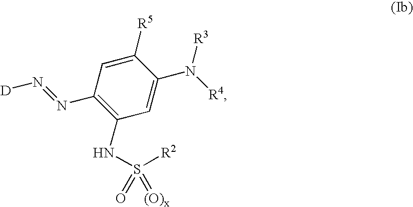
where
D is a five-membered pseudoaromatic heterocyclic radical,
x is 0 or 1,
R² is substituted or unsubstituted C₆-C₁₀-aryl, substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁— to C₆-alkyl-piperidino,
R⁵ is hydrogen, chlorine, methyl or methoxy or
R³;R⁵ together form a —CH₂)₂—, —(CH₂)₃— or —CH₂)₂—O— bridge
where D must not be unsubstituted or substituted thiazol-2-yl, 1,3,4-thiadiazol-2-yl, benzothiazol-2-yl, benzoxazol-2-yl, benzimidazol-2-yl or 1,3,4-triazol-2-yl when x is 1 and R² is substituted or unsubstituted C₆-C₁₀-aryl.
x is preferably 0.

Preference is likewise given to the azo compounds of the formula (Ib) containing no fluorine atoms.

Preferred azo compounds are compounds of the formula (Ib) in which
D is a radical of the formula 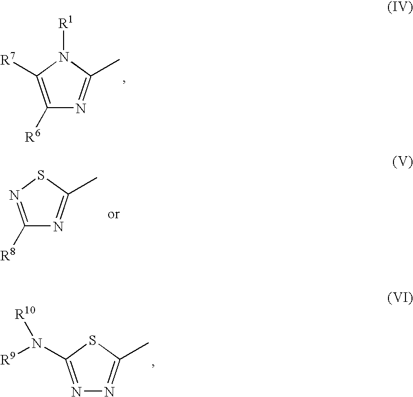
R¹ is hydrogen, substituted or unsubstituted C₁-C₆-alkyl or substituted or unsubstituted C₇-C₁₂-aralkyl,
x is 0 or 1,
R² is substituted or unsubstituted C₆-C₁₀-aryl, substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperazino,
R⁵ is hydrogen, chlorine, methyl or methoxy or
R³;R⁵ together form a —(CH₂)₂—, —(CH₂)₃— or —CH₂)₂—O— bridge,
R⁶ and R⁷ are each, independently of one another, cyano, C₁-C₄-alkoxycarbonyl or —C(═NH)—C₁-C₄-alkyl,
R⁸ is substituted or unsubstituted C₆-C₁₀-aryl, substituted or unsubstituted pyridyl, C₁-C₆-alkylthio, C₇-C₁₀-aralkylthio, substituted or unsubstituted C₆-C₁₀-arylthio, C₁-C₆-alkylsulphonyl, C₇-C₁₀-aralkylsulphonyl or substituted or unsubstituted C₆-C₁₀-arylsulphonyl,
R⁹ and R¹⁰ are each, independently of one another, substituted or unsubstituted C₁-C₆-alkyl, substituted or unsubstituted C₇-C₁₀-aralkyl or substituted or unsubstituted C₆-C₁₀-aryl or
NR⁹R¹⁰ is pyrrolidino, piperidino, morpholino, piperazino or N—C₁-C₆-alkyl-piperidino.

Azo compounds of the formula (Ib) can be prepared by methods analogous to the process of U.S. Pat. No. 5,208,325.

Diazotizations, nitrosations and coupling reactions are known per se from the literature, e.g. from Chem. Ber. 1958, 91, 1025; Chem. Ber. 1961, 94, 2043; U.S. Pat. No. 5,208,325. The procedures described there can be applied in an analogous way.

The aminoimidazoles used to prepare the azo dyes are known, for example, from J. Polym. Sci.: Part A: Polym. Chem. 1993, 31, 351, or can be prepared in an analogous way.

The 5-amino-1,2,4-thiadiazoles to be used for preparing the azo dyes are known, for example, from Chem. Ber. 1954, 87, 68; Chem. Ber. 1956, 89, 1956, 2742; DE-OS 2 811 258, or can be prepared in an analogous way.

The invention further provides the coupling component of the formula (VU) 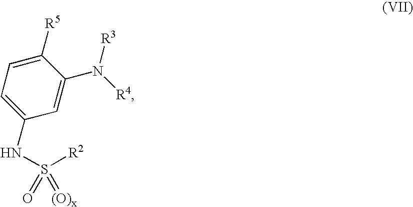
where
x is 0 or 1,
R² is substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperidino,
R⁵ is hydrogen, chlorine, methyl or methoxy or
R³; R⁵ together form a —CH₂)₂—, —(CH₂)₃— or —CH₂)₂—O— bridge.

Preference is given to coupling components of the formula (VII)

in which

R² is a substituted or unsubstituted five- or six-membered aromatic or pseudoaromatic heterocyclic radical.

Particular preference is given to coupling components of the formula (VII)

in which

R² is benzothiazolyl, benzoxazolyl, benzimidazolyl, pyridyl, pyridyl-N-oxide, quinolyl, pyrimidyl or pyrazinyl, which may each be substituted by fluorine, chlorine, cyano, nitro, methyl, ethyl, trifluoromethyl, methoxy, ethoxy, acetamino, carboxyl, carboxamide, methoxycarbonyl, ethoxycarbonyl or phenyl.

These coupling components of the formula (VII) can be prepared, for example, by methods analogous to those of U.S. Pat. No. 6,225,023.

The invention likewise provides a process for preparing the coupling components of the formula (VII), which is characterized in that
an m-phenylenediamine of the formula (VIII) 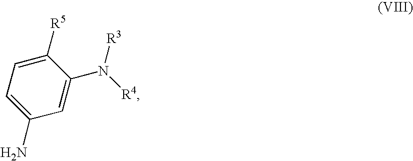
where
R³ and R⁴ are each, independently of one another, substituted or unsubstituted C₁-C₆-5 alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperidino,
R⁵ is hydrogen, chlorine, methyl or methoxy or
R³;R⁵ together form a —CH₂)₂—, —(CH₂)₃— or —CH₂)₂—O— bridge,
   is reacted with a sulphonic acid halide or sulphinic acid halide of the formula (IX) 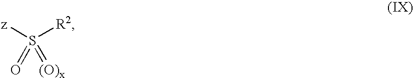
   where
x is 0 or 1,
R² is substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical and
Z is fluorine, chlorine, bromine or iodine.

These reactions can be carried out in the presence of a base, for example a tertiary amine or a sodium or potassium hydroxide, hydrogen carbonate or carbonate.

This gives the coupling component of the formula (V) in free form, as HCl salt or HBr salt.

Suitable solvents are 1,2-dichloroethane, carbon tetrachloride, toluene or else alcohols such as methanol or ethanol and water.

Some sulphonic acid halides and sulphinic acid halides of the formula (IX) are known or can be prepared by analogous methods: J. Amer. Chem. Soc. 72 (1950) 4890, J. Prakt. Chem. 36 (1967) 160, J. Med. Chem. 40 (1997) 1148, J. Med. Chem. 43 (2000) 843.

The invention further provides for the use of the metal complexes of the invention as light-absorbent compounds in the information layer of write-once optical data carriers.

In this use, the optical data carrier is preferably written on and read by means of blue laser light, in particular laser light having a wavelength in the range 360-460 nm.

Preference is likewise given in this use to the optical data carrier being written on and read by means of red laser light, in particular laser light having a wavelength in the range 600-700 nm.

The invention further provides for the use of metal complexes with azo-ligands as light-absorbent compounds in the information layer of write-once optical data carriers which can be written on and read by means of blue laser light, in particular laser light having a wavelength in the range 360-460 nm.

The invention further provides an optical data carrier comprising a preferably transparent substrate which may, if desired, have previously been coated with one or more reflection layers and on whose surface a light-writable information layer, if desired one or more reflection layers and if desired a protective layer or a further substrate or a covering layer have been applied, which can be written on and read by means of blue light, preferably light having a wavelength in the range 360-460 nm, in particular from 390 to 420 nm, very particularly preferably from 400 to 410 nm, or red light, preferably light having a wavelength in the range 600-700 nm, preferably from 620 to 680 nm, very particularly preferably from 630 to 660 nm, preferably laser light, where the information layer comprises a light-absorbent compound and, if desired, a binder, characterized in that at least one metal complex according to the invention is used as light-absorbent compound.

The light-absorbent compound should preferably be able to be changed thermally. The thermal change preferably occurs at a temperature of <600° C., particularly preferably at a temperature of <400° C., very particularly preferably at a temperature of <300° C., in particular <200° C. Such a change can be, for example, a decomposition or chemical change of the chromophoric centre of the light-absorbent compound.

The preferred embodiments of the light-absorbent compounds in the optical data store of the invention correspond to the preferred embodiments of the metal complex of the invention.

In a preferred embodiment, the light-absorbent compounds used are compounds of the formula (Ia), in particular of the formulae (IIa), (IIb) and (IIc), 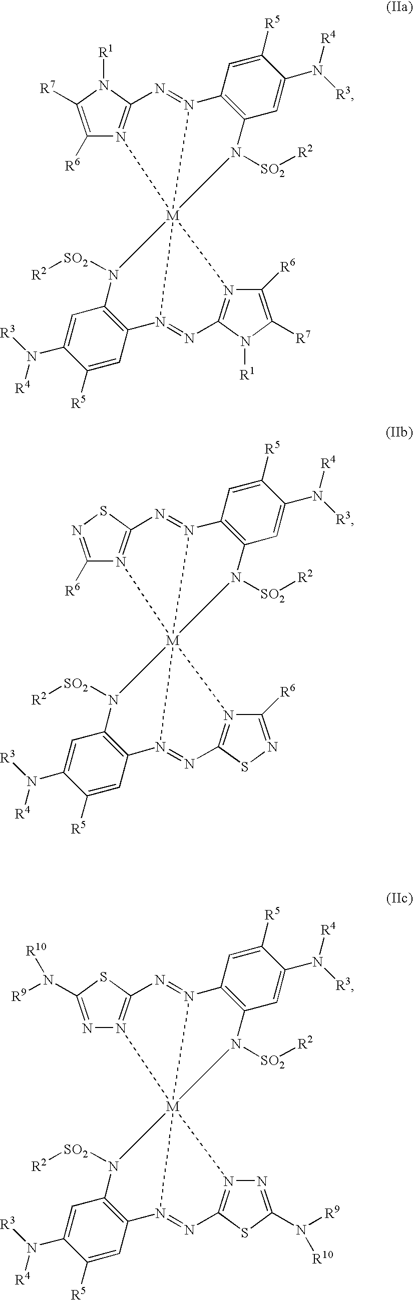
in which
R¹ is methyl, ethyl, propyl, butyl, cyanoethyl, methoxyethyl or benzyl, in particular methyl or ethyl,
R² is phenyl, tolyl, anisyl, chlorophenyl, cyanophenyl, nitrophenyl, dicyanophenyl, dinitrophenyl, styryl, benzothiazol-2-yl, 2-, 3- or 4-pyridyl, 5-nitro-2-pyridyl, 3- or 5-trifluoromethyl-2-pyridyl, 5-cyano-2-pyridyl, tetrachloro-2-pyridyl, pyridine N-oxide-2-yl, 2- or 4-chloro-3-pyridyl, 6-methoxy-3-pyridyl, 5-methyl-3-pyridyl, tetrafluoropyridyl, tetrachloro-4-pyridyl, tetrabromopyridyl, pyridine N-oxide-4-yl, pyrimid-3-yl, in particular phenyl, tolyl, chlorophenyl, styryl, benzothiazol-2-yl, 2-, 3- or 4-pyridyl, 5-nitro-2-pyridyl, 2-chloro-3-pyridyl, tetrachloro-4-pyridyl or pyrimid-3-yl,
R³ and R⁴ are each, independently of one another, methyl, ethyl, propyl, butyl, cyanoethyl, chloroethyl, methoxyethyl, benzyl, phenethyl or phenyl, in particular methyl, ethyl, cyanoethyl, benzyl or phenyl, or
NR³R⁴ is pyrrolidino, piperidino or morpholino, in particular pyrrolidino or piperidino,
R⁵ is hydrogen or
R³;R⁵ is a —CH₂CH₂— or —CH₂CH₂CH₂— bridge,
R⁸ is phenyl, pyridyl, methylthio, ethylthio, propylthio, benzylthio, methylsulphonyl, benzylsulphonyl or phenylsulphonyl, in particular phenyl, pyridyl or phenylsulphonyl,
R⁹ and R¹⁰ are each, independently of one another, methyl, ethyl, propyl, butyl, cyanoethyl, chloroethyl, methoxyethyl, benzyl, phenethyl or phenyl, in particular methyl, ethyl, propyl or cyanoethyl, or
NR⁹R¹⁰ is pyrrolidino, piperidino or morpholino, in particular pyrrolidino or piperidino,
   and
M is Pd, Fe, Zn, Cu, Ni or Co,
   where the propyl or butyl radicals may also be branched.

Very particular preference is given to the compounds of the formulae (IIb) and (IIc).

In a preferred embodiment, the light-absorbent compounds used are compounds of the formula (Ia), in particular of the formulae (IIIa), (IIIb) and (IIIc), 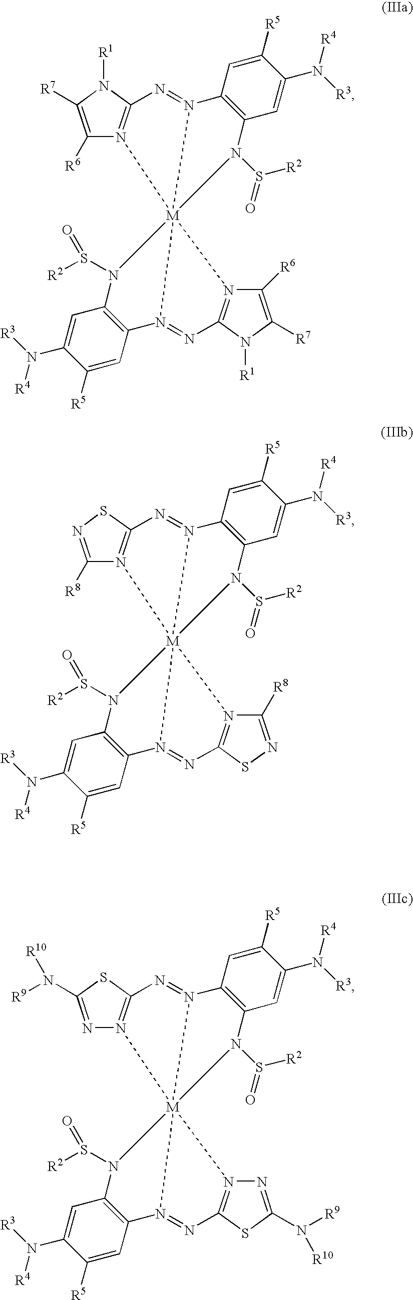
in which
R¹ is methyl, ethyl, propyl, butyl, cyanoethyl, methoxyethyl or benzyl, in particular methyl or ethyl,
R² is phenyl, tolyl, anisyl, chlorophenyl, cyanophenyl, nitrophenyl, dicyanophenyl, dinitrophenyl, styryl, benzothiazol-2-yl, 2-, 3- or 4-pyridyl, 5-nitro-2-pyridyl, 3- or 5-trifluoromethyl-2-pyridyl, 5-cyano-2-pyridyl, tetrachloro-2-pyridyl, pyridine N-oxide-2-yl, 2- or 4-chloro-3-pyridyl, 6-methoxy-3-pyridyl, 5-methyl-3-pyridyl, tetrafluoro-4-pyridyl, tetrachloro-4-pyridyl, tetrabromo-4-pyridyl, pyridine N-oxide-4-yl, pyrimid-3-yl, in particular phenyl, tolyl, chlorophenyl, styryl, benzothiazol-2-yl, 2-, 3- or 4-pyridyl, 5-nitro-2-pyridyl, 2-chloro-3-pyridyl, tetrachloro-4-pyridyl or pyrimid-3-yl,
R³ and R⁴ are each, independently of one another, methyl, ethyl, propyl, butyl, cyanoethyl, chloroethyl, methoxyethyl, benzyl, phenethyl or phenyl, in particular methyl, ethyl, cyanoethyl, benzyl or phenyl, or
NR³R⁴ is pyrrolidino, piperidino or morpholino, in particular pyrrolidino or piperidino,
R⁵ is hydrogen or
R³;R⁵ is a —CH₂CH₂— or CH₂CH₂CH₂— bridge,
R⁸ is phenyl, pyridyl, methylthio, ethylthio, propylthio, benzylthio, methylsulphonyl, benzylsulphonyl or phenylsulphonyl, in particular phenyl, pyridyl or phenylsulphonyl,
R⁹ and R¹⁰ are each, independently of one another, methyl, ethyl, propyl, butyl, cyanoethyl, chloroethyl, methoxyethyl, benzyl, phenethyl or phenyl, in particular methyl, ethyl, propyl or cyanoethyl, or
NR⁹R¹⁰ is pyrrolidino, piperidino or morpholino, in particular pyrrolidino or piperidino,
   and
M is Pd, Fe, Zn, Cu, Ni or Co,
   where the propyl or butyl radicals may also be branched.

In the case of a write-once optical data carrier according to the invention which is written on and read by means of the light of a blue laser, preference is given to light-absorbent compounds whose absorption maximum λₘₐₓ₂ is in the range from 420 to 550 nm, where the wavelength λ_{1/2} at which the absorbence in the short wavelength flank of the absorption maximum at the wavelength λₘₐₓ₂ is half of the absorbence value at λₘₐₓ₂ and the wavelength λ_{1/10} at which the absorbence in the short wavelength flank of the absorption maximum at the wavelength λₘₐₓ₂ is one tenth of the absorbence value at λₘₐₓ₂ are preferably not more than 80 nm apart. Such a light-absorbent compound preferably has no shorter-wavelength maximum λₘₐₓ₁ down to a wavelength of 350 nm, particularly preferably down to 320 nm, very particularly preferably down to 290 nm.

Preference is given to light-absorbent compounds having an absorption maximum λₘₐₓ₂ of from 430 to 550 nm, in particular from 440 to 530 nm, very particularly preferably from 450 to 520 nm.

In the light-absorbent compounds, λ_{1/2} and λ_{1/10}, as defined above, are preferably not more than 70 nm apart, particularly preferably not more than 50 nm apart, very particularly preferably not more than 40 nm apart.

In the case of a write-once optical data carrier according to the invention which is written on and read by means of the light of a red laser, preference is given to light-absorbent compounds whose absorption maximum λₘₐₓ₂ is in the range from 500 to 650 nm, where the wavelength λₘₐₓ₂ at which the absorbence in the long wavelength flank of the absorption maximum at the wavelength λₘₐₓ₂ is half of the absorbence value at λₘₐₓ₂ and the wavelength 80 _{1/10} at which the absorbence in the long wavelength flank of the absorption maximum at the wavelength λₘₐₓ₂ is one tenth of the absorbence value at λₘₐₓ₂ are preferably not more than 60 nm apart. Such a light-absorbent compound preferably has no longer-wavelength maximum λₘₐₓ₃ up to a wavelength of 750 nm, particularly preferably up to 800 nm, very particularly preferably up to 850 nm.

Preference is given to light-absorbent compounds having an absorption maximum λₘₐₓ₂ of from 510 to 620 mm.

Particular preference is given to light-absorbent compounds having an absorption maximum λₘₐₓ₂ of from 530 to 610 nm.

Very particular preference is given to light-absorbent compounds having an absorption maximum λₘₐₓ₂ of from 550 to 600 nm.

In these light-absorbent compounds, λ_{1/2} and λ_{1/10}, as defined above, are preferably not more than 50 nm apart, particularly preferably not more than 40 nm apart, very particularly preferably not more than 30 nm apart.

The light-absorbent compounds preferably have a molar extinction coefficient ε of >30 000 l/mol cm, more preferably >50 000 l/mol cm, particularly preferably >70 000 l/mol cm, very particularly preferably >100 000 l/mol cm, at the absorption maximum λₘₐₓ₂.

The absorption spectra are measured, for example, in solution.

Suitable light-absorbent compounds having the required spectral properties are, in particular, those which have a low solvent-induced wavelength shift (dioxane/DMF or methylene chloride/methanol). Preference is given to metal complexes whose solvent-induced wavelength shift Δλ_{DD}=|λ_{DMF}−λ_{dioxane}|, i.e. the positive difference between the absorption wavelengths in the solvents dimethylformamide and dioxane, or whose solvent-induced wavelength shift Δλ_{MM}=|λₘₑₜₕₐₙₒₗ−λ_{methylene chloride}|, i.e. the positive difference between the absorption wavelengths in the solvents methanol and methylene chloride, is <20 nm, particularly preferably <10 nm, very particularly preferably <5 nm.

Preference is given to a write-once optical data carrier according to the invention which is written on and read by means of the light of a red or blue laser, in particular a red laser.

Other metal complexes are known, for example from U.S. Pat. No. 6,225,023.

The light-absorbent compounds used according to the invention guarantee a sufficiently high reflectivity (preferably >10%, in particular >20%) of the optical data carrier in the unwritten state and a sufficiently high absorption for thermal degradation of the information layer on point-wide illumination with focussed light if the wavelength of the light is in the range from 360 to 460 nm and from 600 to 680 m. The contrast between written and unwritten points on the data carrier is achieved by the reflectivity change of the amplitude and also the phase of the incident light due to the changed optical properties of the information layer after the thermal degradation.

The light-absorbent compounds used according to the invention have a high light stability of the unwritten optical data carrier and of the information inscribed on the data carrier towards daylight, sunlight or under strong artificial radiation in imitation of daylight.

The light-absorbent compounds used according to the invention display a high sensitivity of the optical data carrier towards blue and red laser light of sufficient energy, so that the data carrier can be written on at high speed (≧2×, ≧4×).

The light-absorbent compounds used according to the invention are stable enough for the disk produced using them to meet the climate tests generally required.

The metal complexes of the invention are preferably applied to the optical data carrier by spin coating or vacuum vapour deposition, in particular spin coating. They can be mixed with one another or with other dyes having similar spectral properties. The information layer can comprise not only the metal complexes of the invention but also additives such as binders, wetting agents, stabilizers, diluents and sensitizers and also further constituents. Spin coating is preferably carried out using the above-described solutions of the metal complexes.

Apart from the information layer, further layers such as metal layers, dielectric layers and protective layers may be present in the optical data store of the invention. Metals and dielectric layers serve, inter alia, to adjust the reflectivity and the heat absorption/retention. Metals can be, depending on the laser wavelength, gold, silver, aluminium, etc. Examples of dielectric layers are silicon dioxide and silicon nitride. Protective layers are, for example, photocurable surface coatings, (pressure-sensitive) adhesive layers and protective films.

Pressure-sensitive adhesive layers consist mainly of acrylic adhesives. Nitto Denko DA-8320 or DA-8310, disclosed in the patent JP-A 11-2731471, can, for example, be used for this purpose.

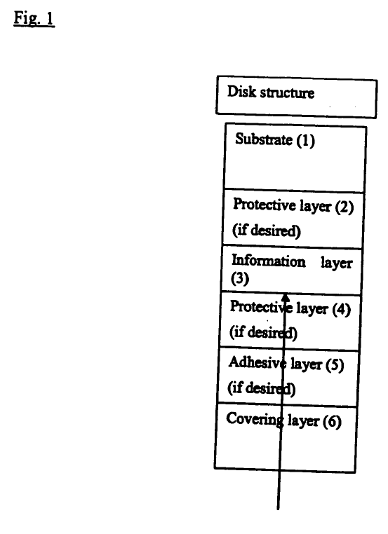

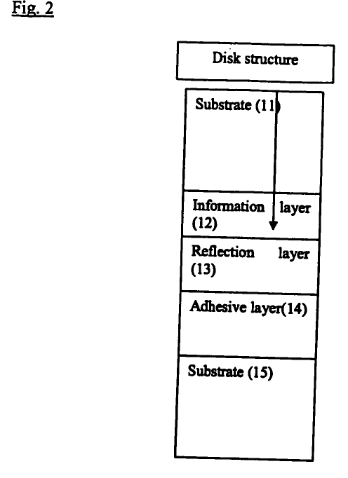

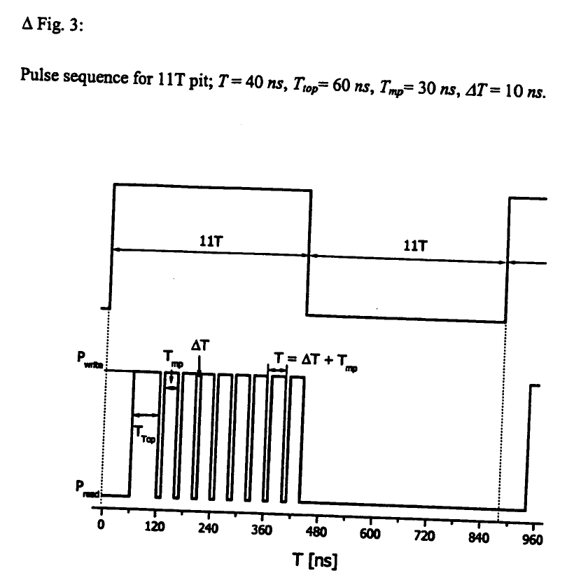

The optical data carrier of the invention has, for example, the following layer structure (cf. FIG. 1): a transparent substrate (1), if desired a protective layer (2), an information layer (3), if desired a protective layer (4), if desired an adhesive layer (5), a covering layer (6). The arrows shown in FIG. 1 and FIG. 2 indicate the path of the incident light.

The structure of the optical data carrier preferably:
comprises a preferably transparent substrate (1) to whose surface at least one light-writable information layer (3) which can be written on by means of light, preferably laser light, if desired a protective layer (4), if desired an adhesive layer (5) and a transparent covering layer (6) have been applied.
comprises a preferably transparent substrate (1) to whose surface a protective layer (2), at least one information layer (3) which can be written on by means of light, preferably laser light, if desired an adhesive layer (5) and a transparent covering layer (6) have been applied.
comprises a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.
comprises a preferably transparent substrate (1) to whose surface at least one information layer (3) which can be written on by means of light, preferably laser light, if desired an adhesive layer (5) and a transparent covering layer (6) have been applied.

Alternatively, the optical data carrier has, for example, the following layer structure (cf FIG. 2): a preferably transparent substrate (11), an information layer (12), if desired a reflection layer (13), if desired an adhesive layer (14), a further preferably transparent substrate (15).

The invention further provides optical data carriers according to the invention which have been written on by means of blue or red light, in particular laser light, in particular red laser light.

The following examples illustrate the subject matter of the invention.

### EXAMPLES

### Example 1

a) 9.71 g of benzenesulphonyl chloride were added dropwise at room temperature to a solution of 8.20 g of N,N-diethyl-m-phenylenediamine in 70 ml of 1,2-dichloroethane over a period of 30 minutes. After stirring overnight at room temperature, the solid was filtered off with suction and dried at 50° C. under reduced pressure. The product was introduced into a mixture of 200 ml of water and 200 ml of chloroform. While stirring well, the pH was adjusted to 8-9 by means of 10 percent strength aqueous sodium hydroxide solution. The organic phase was separated off, washed with 50 ml of water and evaporated on a rotary evaporator. The oil obtained was stirred with 100 ml of methylcyclohexane for 2 hours. The crystals formed were filtered off with suction and dried at room temperature under reduced pressure. This gave 11.7 g (77% of theory) of the sulphonamide of the formula 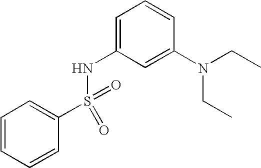
as a grey powder having a melting point of 75-81° C.
b) 3.85 g of 5-amino-3-phenyl-1,2-4-thiadiazole were dissolved in 15 ml of glacial acetic acid and 7.5 ml of formic acid with gentle warming. After cooling to 0° C., 1.5 g of sodium nitrite were introduced over a period of 10 minutes. The mixture was stirred at 0-5° C. for 2 hours.
c) 6.62 g of the sulphonamide from a) were dissolved in 25 ml of glacial acetic acid and cooled to 10° C. The suspension from b) was slowly added at 10° C. over a period of 10 minutes. The mixture was allowed to come to room temperature over a period of 1 hour. It was then heated to 80-85° C. over a period of 30 minutes and maintained at this temperature for 1 hour. After cooling, the solid was filtered off with suction, washed with 3×5 ml of glacial acetic acid and dried at 50° C. under reduced pressure. This gave 4.5 g (42% of theory) of a brownish red powder of the formula 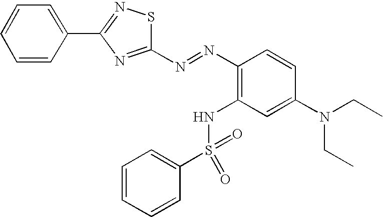
having a melting point of 150-152° C.
   λₘₐₓ in methanol=524 nm.
d) 985 mg of the dye from c) were suspended in 40 ml of methanol. 249 mg of nickel acetate tetrahydrate were added. After stirring overnight at room temperature, the solid was filtered off with suction, washed with 4×6 ml of methanol and dried at 50° C. under reduced pressure. This gave 726 mg (70% of theory) of a red powder of the formula 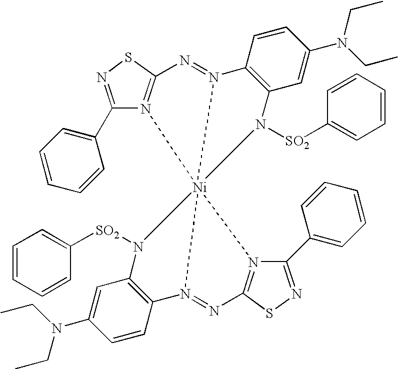
having a melting point of 292-293° C. (decomp.).
   λₘₐₓ=555 nm (chloroform)
   λₘₐₓ=545, 571 nm (methanol)
   ε=90 150 l/mol cm (at 554 nm in chloroform)
   ε=86 415 l/mol cm (at 545 nm in methanol)
   λ_{1/2}-λ_{1/10} (long wavelength flank)=22 nm
   Solubility: >2% in TFP (2,2,3,3-terafluoropropanol), >2% in butanol, >2% in diacetone alcohol vitreous film

Metal complexes which are likewise suitable are presented in the following examples and in the table. These are obtained by analogous preparation of the coupling components, azo dyes and metal complexes.

### Example 2

Use of 249 mg of cobalt (II) acetate tetrahydrate in a procedure analogous to that of Example 1 gave 874 mg (84% of theory) of a red powder of the formula 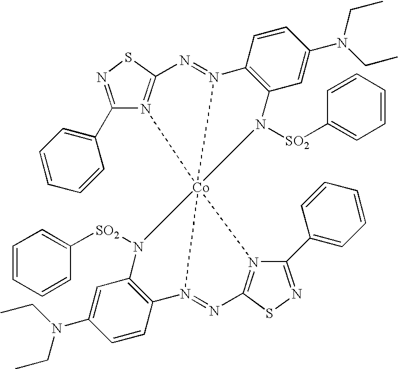
having a melting point of 283-284° C. (decomp.).
λₘₐₓ=549 nm (methylene chloride)
λₘₐₓ=553 nm (methanol)
ε=87 940 l/mol cm (at 549 nm in methylene chloride)
ε=90 090 l/mol cm (at 553 nm in methanol)
λ_{1/2}-λ_{1/10} (long wavelength flank)=30 nm
Δλ=|λₘₑₜₕₐₙₒₗ−λ_{methylene chloride}|=6 nm
Solubility: >2% in TFP (2,2,3,3-tetrafluoropropanol), >1% in butanol, >2% in diacetone alcohol vitreous film

### Example 3

a) 8.00 g of trans-ω-styrenesulphonyl chloride were added dropwise at room temperature to a solution of 6.00 g of N,N-diethyl-m-phenylenediamine in 60 ml of 1,2-dichloroethane over a period of 30 minutes. After stirring overnight at room temperature, the mixture was poured into 250 ml of ice water, the pH was adjusted to 8 by means of aqueous sodium hydroxide solution and the organic phase was separated off. The aqueous phase was extracted with 2×100 ml of methylene chloride. The combined organic phases were evaporated on a rotary evaporator. The oil obtained was stirred with 100 ml of methyl cyclohexane for 2 hours. The solvent was decanted off and the remaining oil was freed of solvent residues under reduced pressure. This gave 4.8 g (39% of theory) of the sulphonamide of the formula 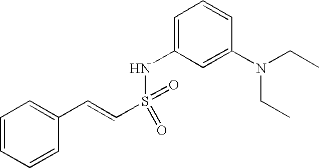
as a light-brown oil.
b) 2.60 g of 5-amino-3-phenyl-1,2-4-thiadiazole were dissolved in 10 ml of glacial acetic acid and 5 ml of formic acid with gentle warming. After cooling to 0° C., 1.0 g of sodium nitrite was introduced over a period of 10 minutes. The mixture was stirred at 0-5° C. for 2 hours.
c) 4.80 g of the sulphonamide from a) were dissolved in 20 ml of glacial acetic acid and cooled to 10° C. The suspension from b) was slowly added at 10° C. over a period of 10 minutes. The mixture was allowed to come to room temperature over a period of 1 hour. It was then heated to 80-85° C. over a period of 30 minutes and maintained at this temperature for 1 hour. After cooling, the solid was filtered off with suction, washed with 2×5 ml of glacial acetic acid and dried at 50° C. under reduced pressure. This gave 2.3 g (30% of theory) of a brownish red powder of the formula 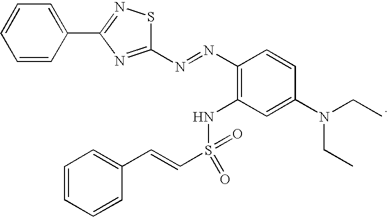
λₘₐₓ in methylene chloride=518 nm.
d) 500 mg of the dye from c) were suspended in 10 ml of methanol. 120 mg of nickel acetate tetrahydrate were added. The mixture was stirred at 60° C. for 2 hours, cooled, the solid was filtered off with suction, washed with 10 ml of petroleum ether and subsequently with 20 ml of water and dried at 50° C. under reduced pressure. The solid was subsequently stirred with 5 ml of toluene at room temperature and once again dried at 50° C. under reduced pressure. This gave 440 mg (80.3% of theory) of a red powder of the formula 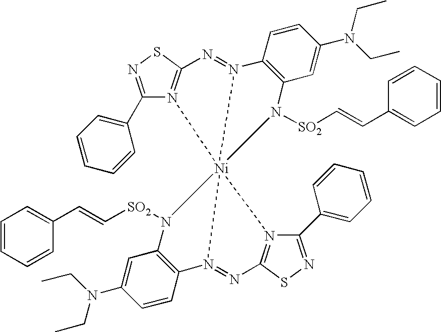
having a melting point of >280° C.
   λₘₐₓ=554 nm (methylene chloride)
   ε=96 450 l/mol cm (at 554 nm in chloroform)
   λ_{1/2}λ_{1/10} (long wavelength flank)=25 nm
   Solubility: >2% in TFP (2,2,3,3-tetrafluoropropanol), vitreous film

### Example 4

a) A solution of 21.2 g of 2-chloropyridine-3-sulphonyl chloride in 100 ml of 1,2-dichloroethane was added dropwise at room temperature to a solution of 16.4 g of N,N-diethyl-m-phenylenediamine in 150 ml of 1,2-dichloroethane over a period of 30 minutes. After stirring overnight at room temperature, the mixture was filtered with suction. The moist filter cake was introduced into a mixture of 300 ml of water and 200 ml of 1,2-dichloroethane. While stirring well, the pH was adjusted to 6-7 by means of solid sodium carbonate. The organic phase was separated off, washed with 100 ml of water, dried over sodium sulphate and evaporated under reduced pressure. The oil obtained was stirred with 200 ml of methylchlorohexane at 50° C. for 2 hours. The crystals formed were filtered off with suction and dried at room temperature under reduced pressure. This gave 15.9 g (58% of theory) of the sulphonamide of the formula 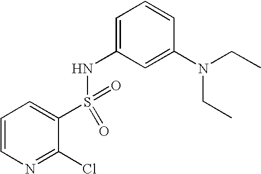
as a grey powder having a melting point of 102-104° C.
b) 5.13 g of 5-amino-3-phenyl-1,2-4-thiadiazole were dissolved in 32 ml of glacial acetic acid, and 9.6 ml of 85% strength by weight phosphoric acid and 1.6 ml of 98% strength by weight sulphuric acid were slowly added. After cooling to 0-5° C., 9.67 g of 40% strength by weight nitrosylsulphuric acid were introduced over a period of 1.5 hours. The mixture was stirred at 0-5° C. for 2 hours.
c) 9.85 g of the sulphonamide from a) were dissolved in 64 ml of glacial acetic acid and cooled to 10° C. The orange suspension from b) was slowly added over a period of 30 minutes at a maximum of 10° C. 56 g of sodium acetate were subsequently introduced and the mixture was diluted with 25 ml of glacial acetic acid. It was allowed to come to room temperature over a period of 1 hour. The solid was filtered off with suction and washed with 2×15 ml of glacial acetic acid. The moist filter cake was suspended in 500 ml of water, filtered off with suction, washed free of salts using 3×100 ml of water and dried at 50° C. under reduced pressure. This gave 12.6 g (82% of theory) of a brownish red powder. This was recrystallised from 60 ml of glacial acetic acid and dried at 50° C. under reduced pressure. This gave 6.58 g (43% of theory) of a brownish red powder of the formula 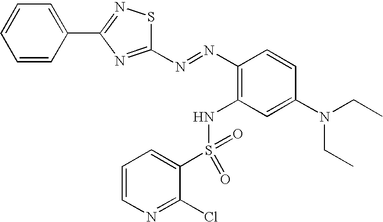
having a melting point of 120-123° C.,
   ₘₐₓ in methanol=524 nm.
d) 2.64 g of the dye from c) were suspended in 100 ml of methanol. 622 mg of nickel acetate tetrahydrate were added. After stirring overnight at room temperature, the solid was filtered off with suction, washed with 3×10 ml of methanol and dried at 50° C. under reduced pressure. This gave 2.3 g (83% of theory) of a brown powder of the formula 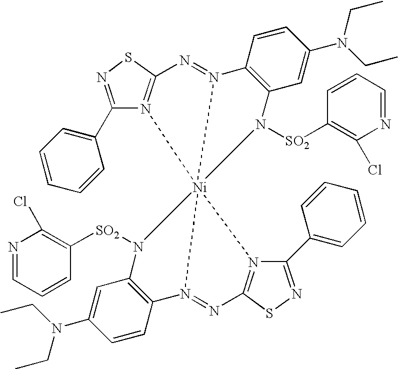
having a melting point of >290° C.
   λₘₐₓ=544, 579 nm (chloroform)
   λₘₐₓ=551, 585 nm (methanol)
   ε=82 080 l/mol cm (at 579 nm in chloroform)
   ε=98 550 l/mol cm (at 585 nm in methanol)
   λ_{1/2}-λ_{1/10} (long wavelength flank)=18 nm (in methanol)
   Solubility: >2% in TFP (2,2,3,3-tetrafluoropropanol)
   gives a vitreous film

### Example 5

Use of 623 mg of cobalt (II) acetate tetrahydrate in a procedure analogous to that of Example 4 gave 2.41 g (87% of theory) of a green powder of the formula 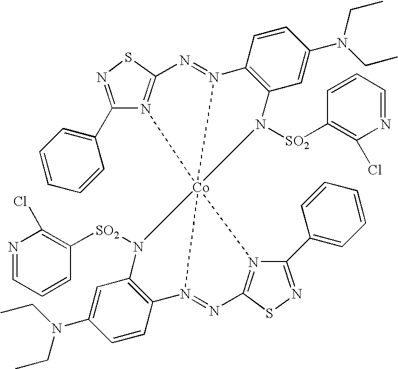
having a melting point of >285° C.
λₘₐₓ=549, 581 nm (chloroform)
λₘₐₓ=543, 581 nm (methanol)
ε=76 900 l/mol cm (at 549 nm in chloroform)
ε=88 205 l/mol cm (at 543 nm in methanol)
λ_{1/2}-λ_{1/10} (long wavelength flank)=28 nm
Solubility: >2% in TFP (2,2,3,3-tetrafluoropropanol), vitreous film

### Example 6

The metal complex of the formula 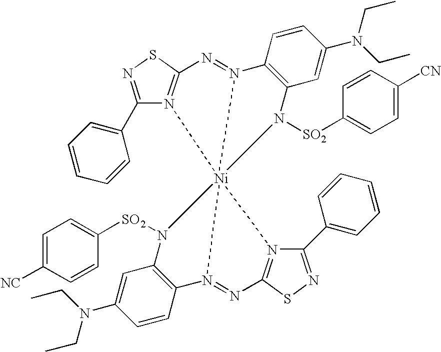
was obtained in a manner analogous to Example 1 and had a melting point of >280° C.
λₘₐₓ=550, 582 nm (methylene chloride)
ε=96 272 l/mol cm (at 550 nm)
λ_{1/2}-λ_{1/10} (long wavelength flank)=19 nm
Solubility: >2% in TFP (2,2,3,3-tetrafluoropropanol), vitreous film

### Example 7

The metal complex of the formula 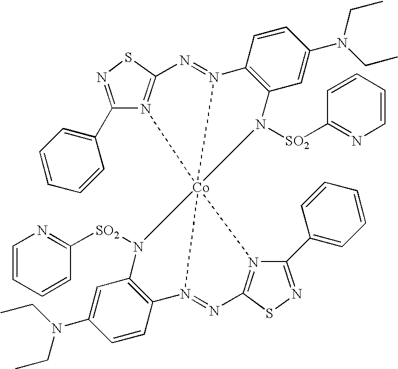
was obtained in a manner analogous to Example 4 and had a melting point of 282-284° C. (decomp.).
λₘₐₓ=553 nm (chloroform)
λₘₐₓ=543 nm (methanol)
ε=93 036 l/mol cm (in chloroform)
ε=91 210 l/mol cm (in methanol)
λ_{1/2}-λ_{1/10} (long wavelength flank)=22 nm (in methanol)

Solubility: >2% in TFP (2,2,3,3-tetrafluoropropanol), vitreous film

TABLE

| Example | D | 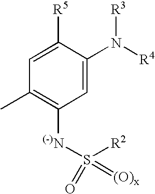 | M |
|---|---|---|---|
| 8 | 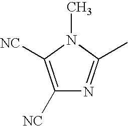 | 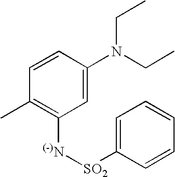 | Ni |
| 9 | 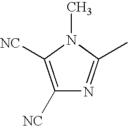 | 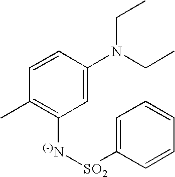 | Co |
| 10 | 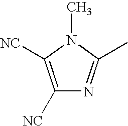 | 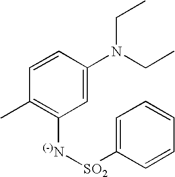 | Zn |
| 11 | 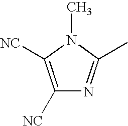 | 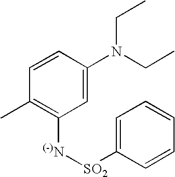 | Cu |
| 12 | 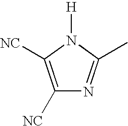 | 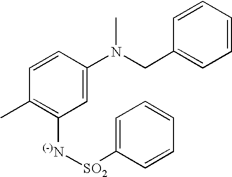 | Ni |
| 13 | 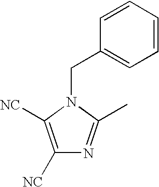 | 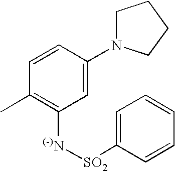 | Ni |
| 14 | 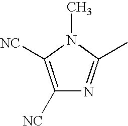 | 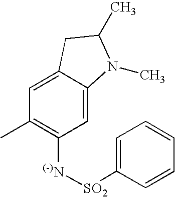 | Ni |
| 15 | 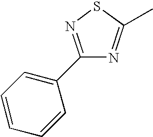 | 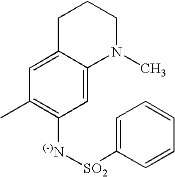 | Co |
| 16 | 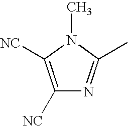 | 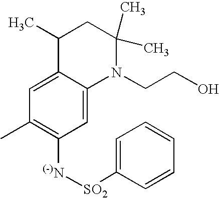 | Cu |
| 17 | 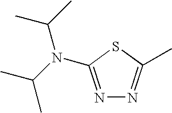 | 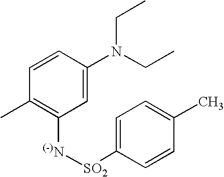 | Zn |
| 18 | 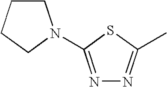 | 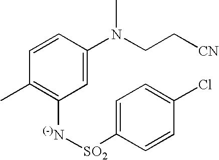 | Pd |
| 19 | 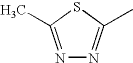 | 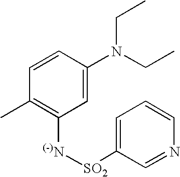 | Fe |
| 20 | 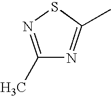 | 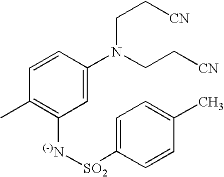 | Ba |
| 21 | 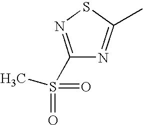 | 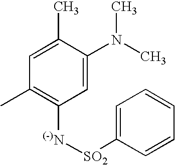 | Ni |
| 22 | 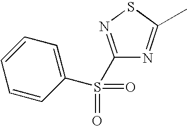 | 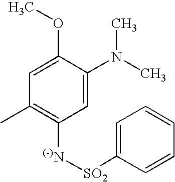 | Ni |
| 23 | 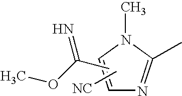 | 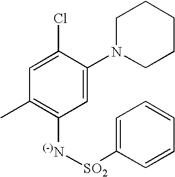 | Co |
| 24 | 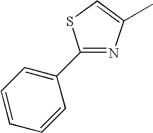 | 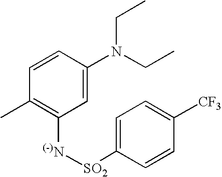 | Ni |
| 25 | 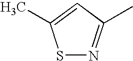 | 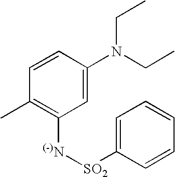 | Co |
| 26 | 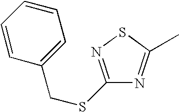 | 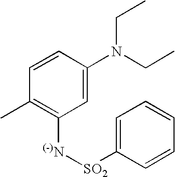 | Ni |
| 27 | 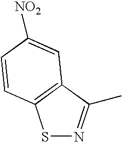 | 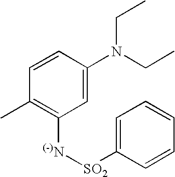 | Zn |
| 28 | 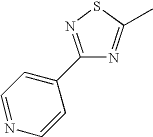 | 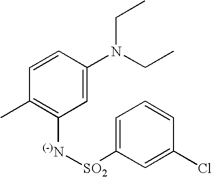 | Fe |
| 29 | 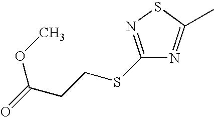 | 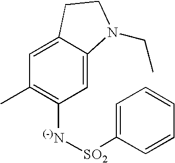 | Pd |
| 30 | 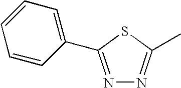 | 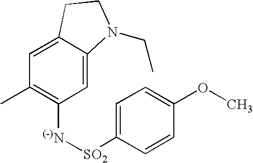 | Ni |
| 31 | 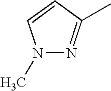 | 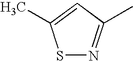 | Co |
| 32 | 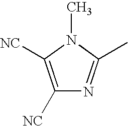 | 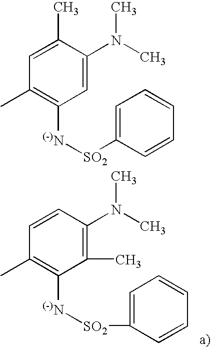 | Ni |
| 33 | 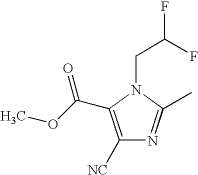 | 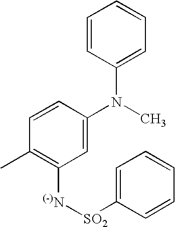 | Ni |
| 34 | 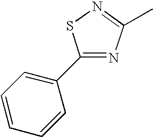 | 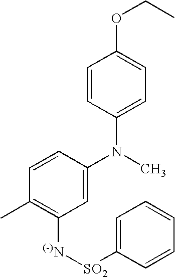 | Ni |
| 35 | 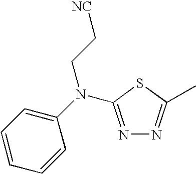 | 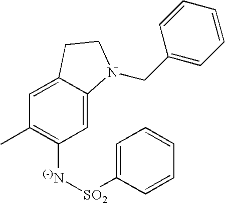 | Ni |
| 36 | 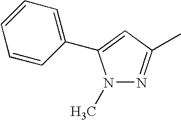 | 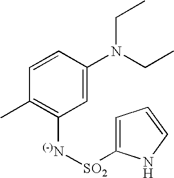 | Ni |
| 37 | 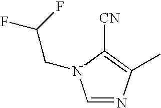 | 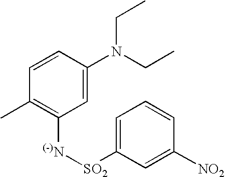 | Ni |
| 38 | 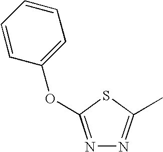 | 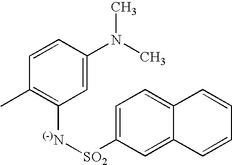 | Co |
| 39 | 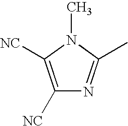 | 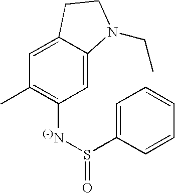 | Ni |
| 40 | 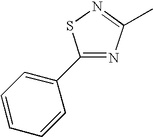 | 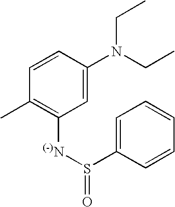 | Ni |
| 41 | 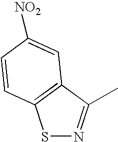 | 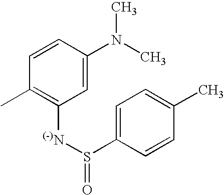 | Co |
| 42 | 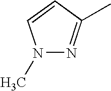 | 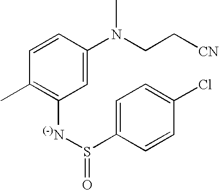 | Ni |
| 43 | 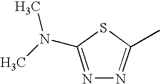 | 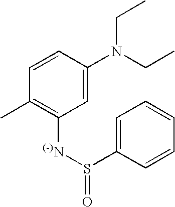 | Zn |
| 44 | 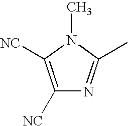 | 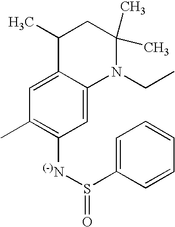 | Ni |
| 45 | 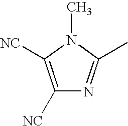 | 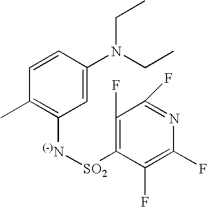 | Ni |
| 46 | 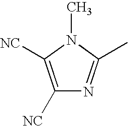 | 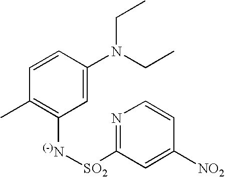 | Ni |
| 47 | 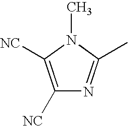 | 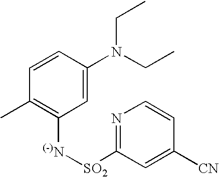 | Ni |
| 48 | 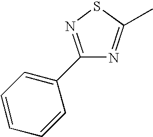 | 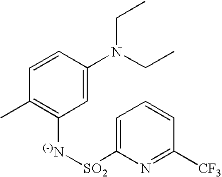 | Ni |
| 49 | 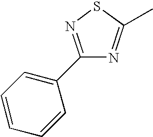 | 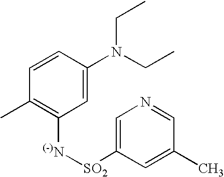 | Co |
| 50 | 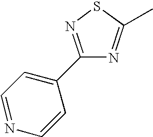 | 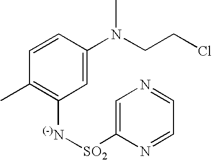 | Ni |
| 51 | 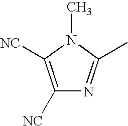 | 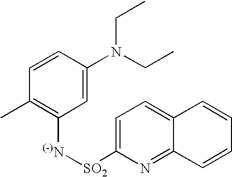 | Ni |
| 52 | 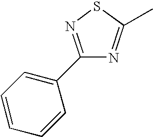 | 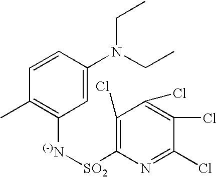 | Ni |
| 53 | 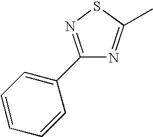 | 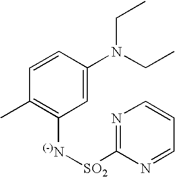 | Ni |
| 54 | 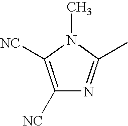 | 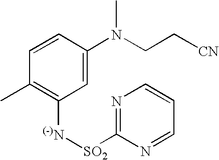 | Co |
| 55 | 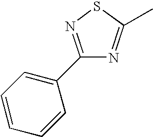 | 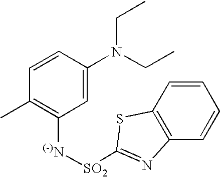 | Ni |
| 56 | 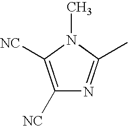 | 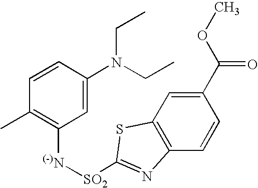 | Ni |
| 57 | 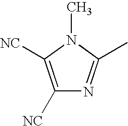 | 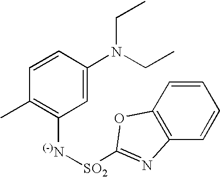 | Cu |
| 58 | 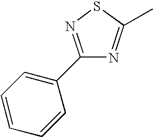 | 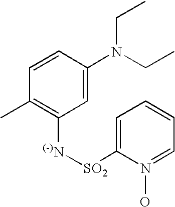 | Ni |
| 59 | 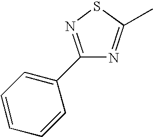 | 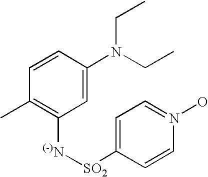 | Ni |

^{a)}Mixture

### Example 60

A 3% strength by weight solution of the dye from Example 1 in 2,2,3,3-tetrafluoropropanol was prepared at room temperature. This solution was applied by means of spin coating to a pregrooved polycarbonate substrate. The pregrooved polycarbonate substrate had been produced as a disk by means of injection moulding. The dimensions of the disk and the groove structure corresponded to those customarily used for DVD-Rs. The disk with the dye layer as information carrier was coated with 100 nm of silver by vapour deposition. A UV-curable acrylic coating composition was subsequently applied by spin coating and cured by means of a UV lamp. The disk was tested by means of a dynamic writing test apparatus constructed on an optical test bench and comprising a diode laser (λ=656 nm), for generating linearly polarized light, a polarization-sensitive beam splitter, a λ/4 plate and a movably suspended collecting lens having a numerical aperture NA=0.6 (actuator lens). The light reflected from the reflection layer of the disk was taken out from the beam path by means of the abovementioned polarization-sensitive beam splitter and focussed by means of an astigmatic lens onto a four-quadrant detector. At a linear velocity V=3.5 m/s and a writing power P_{write}=11 mW, a signal/noise ratio C/N=49 dB was measured for 11T pits. The writing power was applied as an oscillating pulse sequence (cf. FIG. 1), with the disk being irradiated alternately with the abovementioned writing power P_{write} and the reading power P_{read}≈0.5 mW. The writing pulse sequence for the 11T pit comprised a lead pulse having a length Tₜₒₚ=1.5T=60 ns, where T=40 ns is the base time (11T=440 ns). The lead pulse was placed so that it ended after 3T units. It was followed by eight pulses having a length Tₘₚ=30 ns, with the time being determined by Tₘₚ=0.75T. A time interval ΔT=10 ns therefore remains free between each writing pulse. The 11T long writing pulse was followed by an 11T long pause. The disk was irradiated with this oscillating pulse sequence until it had rotated once. The marking produced in this way was then read using the reading power P_{read} and the abovementioned signal/noise ratio C/N was measured.

Analogous results were achieved using the metal complexes from the other examples described above.

1. Metal complexes having at least one ligand of the formula (I) 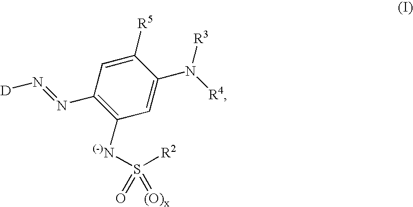
where
D is a five-membered pseudoaromatic heterocyclic radical,
x is 0 or 1,
R² is substituted or unsubstituted C₆-C₁₀-aryl, substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperidino,
R⁵ is hydrogen, chlorine, methyl or methoxy or
R³;R⁵ together form a —CH₂)₂—, —(CH₂)₃— or 4CH₂)₂—O— bridge,
where D must not be unsubstituted or substituted thiazol-2-yl, benzothiazol-2-yl, benzoxazol-2-yl, benzimidazol-2-yl or 1,3,4-triazol-2-yl when x is 1 and R² is substituted or unsubstituted C₆-C₁₀-aryl.

2. Metal complexes according to claim 1, characterized in that they contain two identical or different ligands of the formula (I).

3. Metal complexes according to at least one of claims 1 to 2, characterized in that they have the formula (Ia) 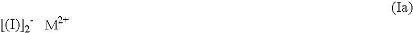
where the two ligands of the formula (I) each have, independently of one another, one of the meanings given in claim 1, and
M is a metal.

4. Metal complexes according to at least one of claims 1 to 3, characterized in that the metal is a divalent metal, transition metal or rare earth, in particular Mg, Ca, Sr, Ba, Cu, Ni, Co, Fe, Zn, Pd, Pt, Ru, Th, Os, Sm.

5. Metal complexes according to at least one of claims 1 to 4, characterized in that the metal is Pd, Fe, Zn, Cu, Ni or Co.

6. Metal complexes according to at least one of claims 1 to 5, characterized in that the ligand of the formula (I) contains no fluorine atoms.

7. Metal complexes according to at least one of claims 1 to 6, characterized in that the radical R² in the ligand of the formula (I) is a substituted or unsubstituted five- or six-membered aromatic or pseudoaromatic heterocyclic radical.

8. Metal complexes according to at least one of claims 1 to 7, characterized in that, in the formula (I),
D is 1,3-thiazol-4-yl, 1,2-thiazol-3-yl, benzoisothiazol-3-yl, 1,3-oxazol-2-yl, 1,2-oxazol-3-yl, imidazol-2-yl, imidazol-4-yl, pyrazol-5-yl, 1,3,4-thiadiazol-2-yl, 1,2,4-thiadiazol-5-yl, 1,2,4-thiadiazol-3-yl or 1,3,4-oxadiazol-2-yl which may each be substituted by C₁-C₆-alkyl, C₁-C₆-alkoxy, fluorine, chlorine, bromine, iodine, cyano, —C(═NH)—O—C₁-C₆-alkyl, nitro, C₁-C₆-alkoxycarbonyl, C₁-C₆-alkylthio, C₁-C₆-acylamino, formyl, C₂-C₆-alkanoyl, C₆-C₁₀-aryl, C₆-C₁₀-aryloxy, C₆-C₁₀-arylcarbonylamino, mono- or di-C₁-C₆-alkylamino, N—C₁-C₆-alkyl-N—C₆-C₁₀-arylamino, pyrrolidino, morpholino, piperazino or piperidino.

9. Metal complexes according to at least one of claims 1 to 7, characterized in that
D is 1,3-thiazol-4-yl which may bear up to two identical or different radicals from the group consisting of chlorine, fluorine, methoxy, methylthio, phenyl and cyano as substituents, imidazol-2-yl which may bear up to two identical or different radicals from the group consisting of chlorine, methyl, methoxy, phenyl, cyano, —C(═NH)—OCH₃, nitro, methoxycarbonyl and ethoxycarbonyl as substituents, pyrazol-5-yl which may bear up to two identical or different radicals from the group consisting of chlorine, methyl, methoxy, phenyl, cyano and nitro as substituents, 1,3,4-thiadiazol-2-yl which may bear chlorine, bromine, methoxy, phenoxy, methanesulphonyl, methylthio, ethylthio, dimethylamino, diethylamino, diisopropylamino, N-methyl-N-cyanoethylamino, N,N-biscyanoethylamino, N-methyl-N-hydroxy-ethylamino, N-methyl-N-benzylamino, N-methyl-N-phenylamino, anilino, pyrrolidino, piperidino or morpholino radicals as substituents, 1,2,4-thiadiazol-5-yl which may bear chlorine, methyl, ethyl, methoxy, phenoxy, methylthio, methanesulphonyl, benzylthio, benzylsulphonyl, benzenesulphonyl, phenyl, pyridyl, dimethylamino or anilino radicals as substituents, 1,2,4-thiadiazol-3-yl which may bear methyl or phenyl radicals as substituents.

10. Metal complexes according to at least one of claims 1 to 9, characterized in that they have at least one ligand of the formula (I) 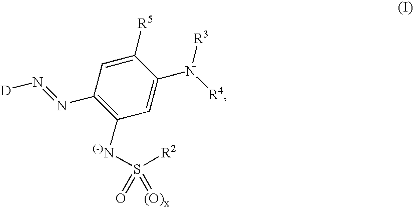
in which
D is a radical of the formula 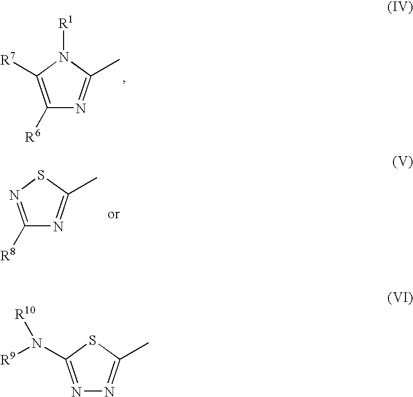
R¹ is hydrogen, substituted or unsubstituted C₁-C₆-alkyl or substituted or unsubstituted C₇-C₁₂-aralkyl,
x is 0 or 1,
R² is substituted or unsubstituted C₆-C₁₀-aryl, substituted or unsubstituted C₆-C₁₀-aryl-vinyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperazino,
R⁵ is hydrogen, chlorine, methyl or methoxy or
R³;R⁵ together form a —CH₂)₂—, —(CH₂)₃— or —(CH₂)₂—O— bridge,
R⁶ and R⁷ are each, independently of one another, cyano, C₁-C₄-alkoxycarbonyl or —C(═NH)—C₁-C₄-alkyl,
R⁸ is substituted or unsubstituted C₆-C₁₀-aryl, substituted or unsubstituted pyridyl, C₁-C₆-alkylthio, C₇-C₁₀-aralkylthio, substituted or unsubstituted C₆-C₁₀-arylthio, C₁-C₆-alkylsulphonyl, C₇-C₁₀-aralkylsulphonyl or substituted or unsubstituted C₆-C₁₀-arylsulphonyl,
R⁹ and R¹⁰ are each, independently of one another, substituted or unsubstituted C₁-C₆-alkyl, substituted or unsubstituted C₇-C₁₀-aralkyl or substituted or unsubstituted C₆-C₁₀-aryl or
NR⁹R¹⁰ is pyrrolidino, piperidino, morpholino, piperazino or N—C₁-C₆-alkyl-piperidino.

11. Metal complexes according to at least one of claims 1 to 10, characterized in that they are in the form of the formulae (IIa) to (IIc) and (IIIa) to (IIIc) 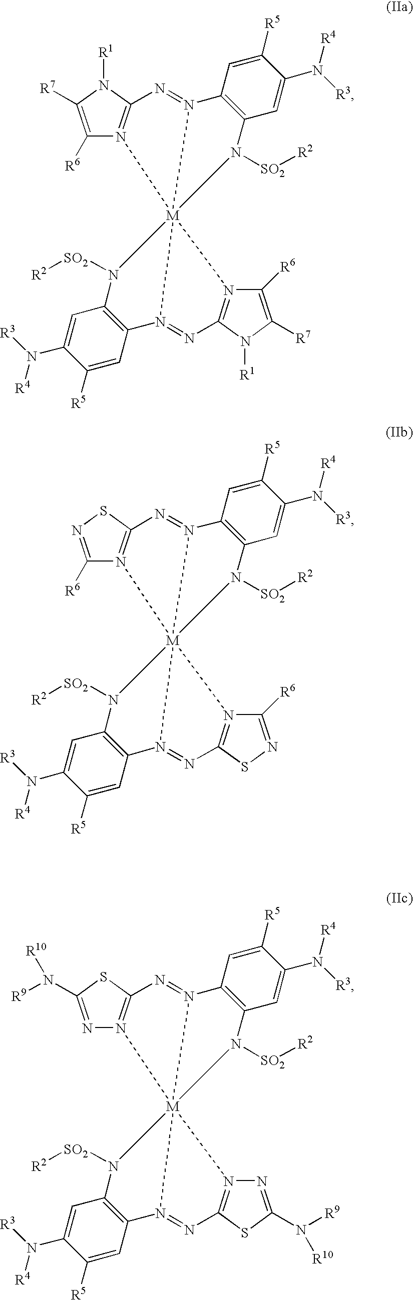 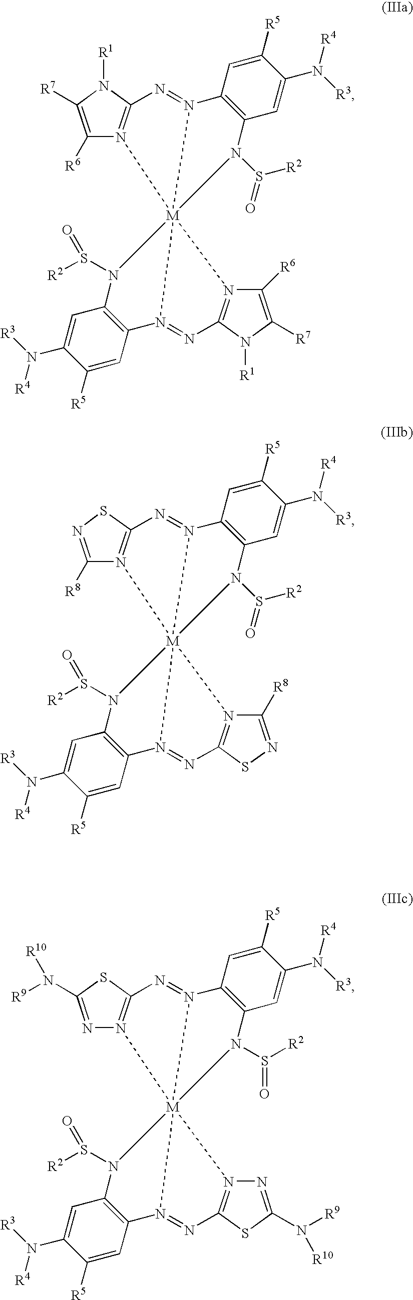
where
M and the radicals on the respective azo ligands each have, independently of one another, one of the meanings given in claims 1 to 10.

12. Metal complexes according to claim 11, characterized in that, in the formulae (IIa) to (IIc) and (IIIa) to (IIIc),
R¹ is methyl, ethyl, propyl, butyl, cyanoethyl, methoxyethyl or benzyl, in particular methyl or ethyl,
R² is phenyl, tolyl, anisyl, chlorophenyl, cyanophenyl, nitrophenyl, dicyanophenyl, dinitrophenyl, styryl, benzothiazol-2-yl, 2-, 3- or 4-pyridyl, 5-nitro-2-pyridyl, 3- or 5-trifluoromethyl-2-pyridyl, 5-cyano-2-pyridyl, tetrachloro-2-pyridyl, pyridine N-oxide-2-yl, 2- or 4-chloro-3-pyridyl, 6-methoxy-3-pyridyl, 5-methyl-3-pyridyl, tetrafluoro-4-pyridyl, tetrachloro-4-pyridyl, tetrabromo-4-pyridyl, pyridine N-oxide-4-yl, pyrimid-3-yl, in particular phenyl, tolyl, chlorophenyl, styryl, benzothiazol-2-yl, 2-, 3- or 4-pyridyl, 5-nitro-2-pyridyl, 2-chloro-3-pyridyl, tetrachloro-4-pyridyl or pyrimid-3-yl,
R³ and R⁴ are each, independently of one another, methyl, ethyl, propyl, butyl, cyanoethyl, chloroethyl, methoxyethyl, benzyl, phenethyl or phenyl, in particular methyl, ethyl, cyanoethyl, benzyl or phenyl, or
NR³R⁴ is pyrrolidino, piperidino or morpholino, in particular pyrrolidino or piperidino,
R⁵ is hydrogen or
R³;R⁵ is a —CH₂CH₂— or —CH₂CH₂CH₂— bridge,
R⁵ is phenyl, pyridyl, methylthio, ethylthio, propylthio, benzylthio, methylsulphonyl, benzylsulphonyl or phenylsulphonyl, in particular phenyl, pyridyl or phenylsulphonyl,
R⁹ and R¹⁰ are each, independently of one another, methyl, ethyl, propyl, butyl, cyanoethyl, chloroethyl, methoxyethyl, benzyl, phenethyl or phenyl, in particular methyl, ethyl, propyl or cyanoethyl, or
NR⁹R¹⁰ is pyrrolidino, piperidino or morpholino, in particular pyrrolidino or piperidino,
and
M is Pd, Fe, Zn, Cu, Ni or Co,
where the propyl or butyl radicals may also be branched.

13. Use of metal complexes according to claim 1 as light-absorbent compounds in the information layer of write-once optical data carriers.

14. Use according to claim 13, characterized in that the optical data carrier can be written on and read by means of blue laser light, in particular laser light having a wavelength in the range 360-460 nm.

15. Use according to claim 13, characterized in that the optical data carrier can be written on and read by means of red laser light, in particular laser light having a wavelength in the range 600-700 nm.

16. Azo compounds of the formula (Ib) 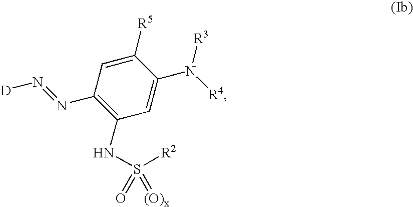
where
D is a five-membered pseudoaromatic heterocyclic radical,
x is 0 or 1,
R² is substituted or unsubstituted C₆-C₁₀-aryl, substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N-C₁- to C₆-alkyl-piperidino,
R⁵ is hydrogen, chlorine, methyl or methoxy or
R³;R⁵ together form a —(CH₂)₂—, —(CH₂)₃— or —CH₂)₂—O— bridge
where D must not be unsubstituted or substituted thiazol-2-yl, 1,3,4-thiadiazol-2-yl, benzothiazol-2-yl, benzoxazol-2-yl, benzimidazol-2-yl or 1,3,4-triazol-2-yl when x is 1 and R² is substituted or unsubstituted C₆-C₁₀-aryl.

17. Azo compounds according to claim 16, characterized in that they have no fluorine atoms.

18. Azo compounds according to claim 16 or 17, characterized in that, in the formula (Ib),
D is a radical of the formula 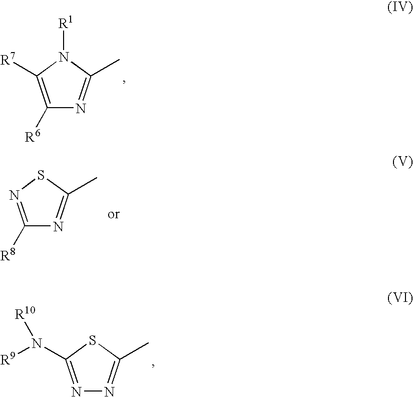
R¹ is hydrogen, substituted or unsubstituted C₁-C₆-alkyl or substituted or unsubstituted C₇-C₁₂-aralkyl,
R² is substituted or unsubstituted C₆-C₁₀-aryl, substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperazino,
R⁵ is hydrogen, methyl or methoxy or
R³;R⁵ together form a —CH₂)₂—, —(CH₂)₃— or —(CH₂)₂—O— bridge,
R⁶ and R⁷ are each, independently of one another, cyano, C₁-C₄-alkoxycarbonyl or —C(═NH)—C₁-C₄-alkyl,
R⁸ is substituted or unsubstituted C₆-C₁₀-aryl, substituted or unsubstituted pyridyl, C₁-C₆-alkylthio, C₇-C₁₀-aralkylthio, substituted or unsubstituted C₆-C₁₀-arylthio, C₁-C₆-alkylsulphonyl, C₇-C₁₀-aralkylsulphonyl or substituted or unsubstituted C₆-C₁₀-arylsulphonyl,
R⁹ and R¹⁰ are each, independently of one another, substituted or unsubstituted C₁-C₆-alkyl, substituted or unsubstituted C₇-C₁₀-aralkyl or substituted or unsubstituted C₆-C₁₀-aryl or
NR⁹R¹⁰ is pyrrolidino, piperidino, morpholino, piperazino or N—C₁-C₆-alkyl-piperidino.

19. Process for preparing metal complexes according to at least one of claims 1 to 12, characterized in that a metal salt is reacted with an azo compound of the formula (b) 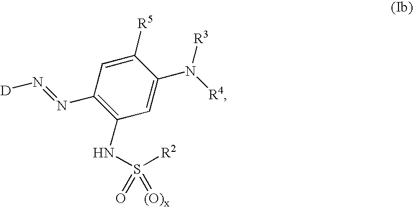
where
D is a five-membered pseudoaromatic heterocyclic radical,
x is 0 or 1,
R² is substituted or unsubstituted C₆-C₁₀-aryl, substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N-C₁- to C₆-alkyl-piperidino,
R⁵ is hydrogen, chlorine, methyl or methoxy or
R³;R⁵ together form a —(CH₂)₂—, —(CH₂)₃— or —(CH₂)₂—O— bridge
where D must not be unsubstituted or substituted thiazol-2-yl, benzothiazol-2-yl, benzoxazol-2-yl, benzimidazol-2-yl or 1,3,4-triazol-2-yl when x is 1 and R² is substituted or unsubstituted C₆-C₁₀-aryl.

20. Coupling component of the formula (VII) 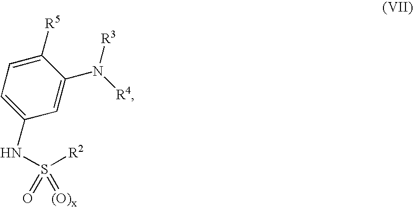
where
x is 0 or 1,
R² is substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperidino,
R⁵ is hydrogen, chlorine, methyl or methoxy or
R³; R⁵ together form a —CH₂)₂—, —(CH₂)₃— or —(CH₂)₂—O— bridge.

21. Process for preparing coupling components of the formula (VI), characterized in that
an m-phenylenediamine of the formula (VIII) 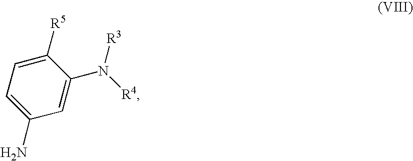
where
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperidino,
R⁵ is hydrogen, chlorine, methyl or methoxy or
R³;R⁵ together form a —CH₂)₂—, —(CH₂)₃— or —(CH₂)₂—O— bridge,
is reacted with a sulphonic acid halide or sulphinic acid halide of the formula (ID) 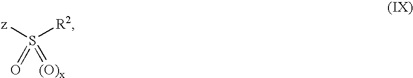
where
x is 0 or 1,
R² is substituted or unsubstituted C₆-C₁₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical and
Z is fluorine, chlorine, bromine or iodine.

22. Solution of metal complexes according to claim 1, characterized in that it contains at least 1% by weight of the metal complex and in that the solvent used is 2,2,3,3-tetrafluoropropanol, propanol, butanol, pentanol, hexanol, diacetone alcohol, dibutyl ether, heptanone or a mixture thereof.

23. Solution of metal complexes according to claim 22, characterized in that the solvent used is propanol, butanol, pentanol, hexanol, diacetone alcohol or a mixture thereof.

24. Solution of metal complexes according to claim 22 or 23, characterized in that the solvent used is a mixture of propanol/diacetone alcohol or butanol/diacetone alcohol in a mixing ratio of from 80:20 to 99:1.

25. Optical data carrier comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written on or read by means of blue or red light, preferably laser light, where the information layer comprises a light-absorbent compound and, if desired, a binder, characterized in that at least one metal complex according to at least one of claims 1 to 11 is used as light-absorbent compound.

26. Optical data carrier according to claim 25, characterized in that the light-absorbent compound has the formula (Ia), 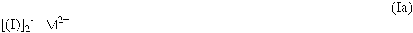
where the formula (I) is as defined in claim 1 and M is a metal.

27. Optical data carrier according to at least one of claims 25 and 26, characterized in that the metal M is a divalent metal, transition metal or rare earth, in particular Mg, Ca, Sr, Ba, Cu, Ni, Co, Fe, Zn, Pd, Pt, Ru, Rh, Os or Sm.

28. Optical data carrier according to one or more of claims 25 to 26, characterized in that a metal complex having at least one ligand of the formula (I) 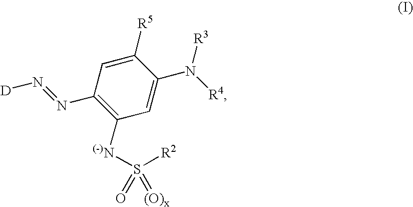
where
D is a five-membered pseudoaromatic heterocyclic radical,
x is 0 or 1,
R² is substituted or unsubstituted C₆-C₁₀-aryl, substituted or unsubstituted C₆-C₀₀-aryl-vinyl, substituted or unsubstituted C₆-C₁₀-aryl-ethynyl, substituted or unsubstituted C₆-C₁₀-aryl-butadienyl or a substituted or unsubstituted five- or six-membered aromatic or pseudoaromatic heterocyclic radical,
R³ and R⁴ are each, independently of one another, substituted or unsubstituted C₁-C₆-alkyl, C₇-C₁₀-aralkyl or substituted or unsubstituted C₆-C₁₀-aryl or
NR³R⁴ is pyrrolidino, piperidino, morpholino, piperazino or N—C₁-C₆-alkyl-piperidino,
R⁵ is hydrogen, chlorine, methyl or methoxy or
R³;R⁵ together form a —CH₂)₂—, —(CH₂)₃— or —CH₂)₂—O— bridge,
where D must not be unsubstituted or substituted thiazol-2-yl, benzothiazol-2-yl, benzoxazol-2-yl, benzimidazol-2-yl or 1,3,4-triazol-2-yl when x is 1 and R² is substituted or unsubstituted C₆-C₁₀-aryl,
is used as light-absorbent compound.

29. Optical data carrier according to one or more of claims 25 to 28, characterized in that a metal complex of one of the formulae (IIa) to (IIc) or (IIa) to (IIc) 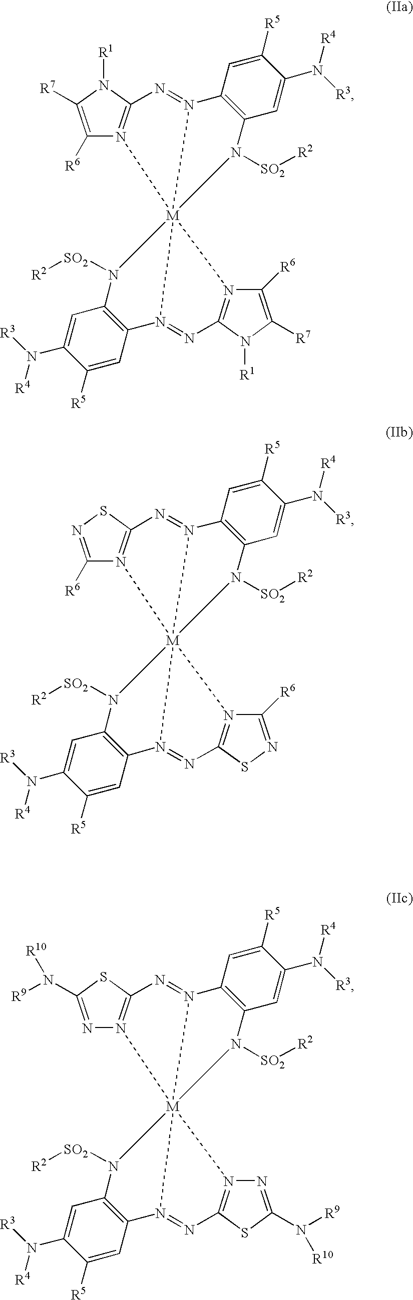 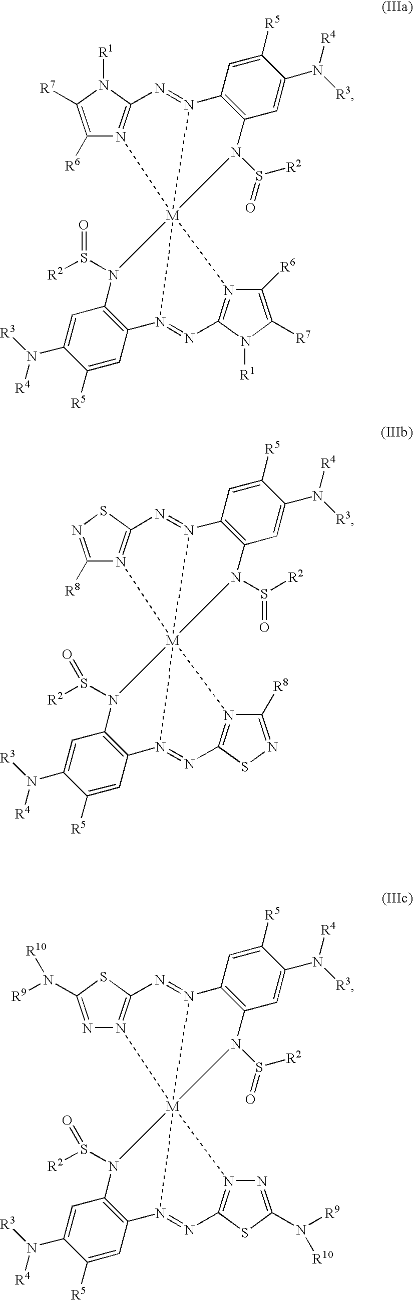
where
R¹ is methyl, ethyl, propyl, butyl, cyanoethyl, methoxyethyl or benzyl, in particular methyl or ethyl,
R² is phenyl, tolyl, anisyl, chlorophenyl, cyanophenyl, nitrophenyl, dicyanophenyl, dinitrophenyl, styryl, benzothiazol-2-yl, 2-, 3- or 4-pyridyl, 5-nitro-2-pyridyl, 3- or 5-trifluoromethyl-2-pyridyl, 5-cyano-2-pyridyl, tetrachloro-2-pyridyl, pyridine N-oxide-2-yl, 2- or 4-chloro-3-pyridyl, 6-methoxy-3-pyridyl, 5-methyl-3-pyridyl, tetrafluoro-4-pyridyl, tetrachloro-4-pyridyl, tetrabromo-4-pyridyl, pyridine N-oxide-4-yl, pyrimid-3-yl, in particular phenyl, tolyl, chlorophenyl, styryl, benzothiazol-2-yl, 2-, 3- or 4-pyridyl, 5-nitro-2-pyridyl, 2-chloro-3-pyridyl, tetrachloro-4-pyridyl or pyrimid-3-yl,
R³ and R⁴ are each, independently of one another, methyl, ethyl, propyl, butyl, cyanoethyl, chloroethyl, methoxyethyl, benzyl, phenethyl or phenyl, in particular methyl, ethyl, cyanoethyl, benzyl or phenyl, or
NR³R⁴ is pyrrolidino, piperidino or morpholino, in particular pyrrolidino or piperidino,
R⁵ is hydrogen or
R³;R⁵ is a —CH₂CH₂— or —CH₂CH₂CH₂— bridge,
R⁸ is phenyl, pyridyl, methylthio, ethylthio, propylthio, benzylthio, methylsulphonyl, benzylsulphonyl or phenylsulphonyl, in particular phenyl, pyridyl or phenylsulphonyl,
R⁹ and R¹⁰ are each, independently of one another, methyl, ethyl, propyl, butyl, cyanoethyl, chloroethyl, methoxyethyl, benzyl, phenethyl or phenyl, in particular methyl, ethyl, propyl or cyanoethyl, or
NR⁹R¹⁰ is pyrrolidino, piperidino or morpholino, in particular pyrrolidino or piperidino,
and
M is Pd, Fe, Zn, Cu, Ni or Co,
where the propyl or butyl radicals may also be branched,
is used as light-absorbent compound.

30. Process for producing the optical data carriers according to claim 25, which is characterized in that a preferably transparent substrate which may, if desired, have previously been coated with a reflection layer is coated with metal complexes according to claim 1, if desired in combination with suitable binders and additives and, if desired, suitable solvents, and provided, if desired, with a reflection layer, further intermediate layers and, if desired, a protective layer or a further substrate or a covering layer.

31. Process for producing the optical data carriers according to claim 30, characterized in that the solutions according to claim 22 are used for coating with the metal complexes.

32. Optical data carriers according to claim 25 which have been written on by means of blue or red light, in particular red light, in particular red laser light.
